(19) United States
(12) Patent Application Publication
(10) Pub. No.: US 2026/0140567 A1
(43) Pub. Date: May 21, 2026

(54) SYSTEMS AND METHODS FOR PROVIDING A COLLABORATIVE EXTENDED REALITY ENVIRONMENT

(71) Applicant: State Farm Mutual Automobile Insurance Company, Bloomington, IL (US)

(72) Inventors: Jody A. Thoele, Bloomington, IL (US); Antonio Cunanan, Richardson, TX (US); Wesley Mao, Murphy, TX (US); David Herrera, Bloomington, IL (US)

(21) Appl. No.: 19/329,716

(22) Filed: Sep. 16, 2025

Related U.S. Application Data
(60) Provisional application No. 63/701,820, filed on Oct. 1, 2024.

(51) Int. Cl. G06F 3/01

(52) U.S. Cl. CPC G06F 3/011

(57) ABSTRACT

A computing system for collaborative interactions between virtual and real-world environments using an extended reality collaboration environment is provided. The computing system includes a processor configured to: (i) present the extended reality collaboration environment including a personalized avatar of a first user wherein the extended reality collaboration environment corresponds to a real-time representation of a physical space; (ii) receive sensor data from a sensor configured to capture real-time and/or historical aspects of the physical space; (iii) generate the extended reality collaboration environment corresponding to the physical space; (iv) receive user sensor data from the first user device; (v) enable interaction between the first user and the physical space within the extended reality collaboration environment based upon the user inputs from the first user device; and (vi) present the interaction between the first user and the physical space within the extended reality collaboration environment.

### CROSS-REFERENCE TO RELATED APPLICATIONS

This application claims the benefit of priority to U.S. Provisional Patent Application No. 63/701,820, filed Oct. 1, 2024, entitled “SYSTEMS AND METHODS FOR PROVIDING A COLLABORATIVE EXTENDED REALITY ENVIRONMENT,” the entire content and disclosure of which is hereby incorporated herein by reference in its entirety.

### FIELD OF DISCLOSURE

The present disclosure relates to providing enhanced virtual reality interactions and, more particularly, to network-based systems and methods for generating a virtual reality collaboration environment that enables collaboration between physical space users within the virtual reality collaboration environment.

### BACKGROUND

The metaverse is designed for millions of users to interact with each other at any moment in time, as well as 24 hours a day, 7 days a week, all of the time. Since the metaverse may be a hosted virtual reality, individual users may desire to interact with other individuals through an avatar, both real and fictional. However, live individuals, either as an avatar or as a live person, may only be able to interact with one or a few users at a time and may not be available all of the time.

In the metaverse, it may be also desirable to increase trust and confidence of the user in the individuals interacting with the user within the metaverse, and for the individuals to appropriately respond to any questions, statements, gestures, or an emotional state of the user displayed within the metaverse. Conventional techniques may include additional inefficiencies, encumbrances, ineffectiveness, and/or other drawbacks as well.

### BRIEF SUMMARY

The present embodiments may relate to, inter alia, computer systems and methods for enhanced virtual reality interactions for collaboration purposes. In the exemplary embodiment, the systems and methods may generate an extended reality collaboration environment that includes one or more avatars and one or more virtual locations and/or physical locations that may be visited by a user avatar controlled by a user with a user computing device (e.g., an AR or VR headset and/or other AR or VR system). These virtual and/or physical locations may include places of business, such as insurance agencies, or other locations having real-world counterparts, and may be occupied by user avatars (e.g., if the virtual user may be available live) and/or avatars associated with a replica persona of the virtual user (e.g., if the virtual user may be not available live). By visiting locations virtually, the user may purchase products, obtain information about the business, and/or collaborate with other uses, for example, by viewing overlays or aspects of the extended reality collaboration environment itself (e.g., virtual signage or documents included in the extended reality collaboration environment) and/or by interacting with an avatar associated with the corresponding virtual user (e.g., by asking questions and receiving responses from the virtual user or the virtual user's virtual replicant).

By visiting and collaborating in a virtual setting, the user does not need to physically travel to interact with different virtual users, therefore making it easier for users in remote locations to interact with one or more virtual users, and also making it easier for users to identify a virtual user having attributes (e.g., background, affinity, demographics, technical skills, language skills, experience, education, hobbies, etc.) compatible with or considered desirable by the user. For example, by visiting one or more virtual locations, users can get to know different virtual users by interviewing and/or viewing information (e.g., introductory videos) relating to the virtual user. Additionally, data provided by the user or virtual user may be recorded and stored in a database, so that the data may be retrieved seamlessly for future interactions within the extended reality collaboration environment and for traditional interactions outside of the extended reality collaboration environment. For example, interactions within the extended reality collaboration environment may be used to process any transactions that may have occurred within the extended reality collaboration environment.

In the exemplary embodiment, the systems and methods provide for enhanced virtual reality interactions for collaboration purposes. The systems and methods may generate an extended reality collaboration environment that may include (i) multiple avatars each corresponding to a real person that may be located in different physical locations from one another but are presented in a virtual location (e.g., extended reality collaboration environment) together for collaboration purposes, and/or (ii) one or more real persons located in a real location in combination with one or more avatars each corresponding or representing a real person who may be also located virtually within the real location to create the extended reality collaboration environment. In other words, the extended reality collaboration environment may include virtual creations of real people (avatars) and/or actual real people in a real location or within a virtual location for collaboration purposes. For example, a first friend who lives in Las Vegas decides to meet up with a second friend who lives in New York for coffee. The two friends may use the system described herein the meet in a virtual coffee shop that may be a digital twin of the two friends' favorite coffee shop. The two friends would see the other's avatar when having coffee together. Alternatively, one of the friends may be inside a physical coffee shop having coffee and then see the avatar of the other friend in the coffee shop, and the two friends would experience having coffee together in the physical coffee shop which may appear in the virtual environment.

In one aspect, a computing system for collaborative interactions between virtual and real-world environments using an extended reality collaboration environment is provided. The computing system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ChatGPT or ChatGPT-based bots, and/or other electronic or electrical components, which may be in wired or wireless communication with one another. For example, in one instance, the computing system may include at least one processor and/or associated transceiver in communication with at least one memory device. The at least one processor may be programmed to: (i) communicate with one or more user devices to cause the one or more user devices to present the extended reality collaboration environment including a personalized avatar of a first user associated with a first user device of the one or more user devices, wherein the extended reality collaboration environment corresponds to a real-time representation of a physical space; (ii) receive sensor data from a sensor including data representing the physical space, the sensor data comprising sensor data from at least one of: a camera, a microphone, a motion sensor, an environmental sensor, and other sensor devices configured to capture real-time and/or historical aspects of the physical space; (iii) generate the extended reality collaboration environment corresponding to the physical space based at least upon the received sensor data, wherein the extended reality collaboration environment comprises a virtual representation of the physical space with the personalized avatar of the first user; (iv) receive user sensor data from the first user device, the user sensor data corresponding to user inputs from the first user device; (v) enable interaction between the first user and the physical space within the extended reality collaboration environment based on the user inputs from the first user device; and (vi) present the interaction between the first user and the physical space within the extended reality collaboration environment on the one or more additional user devices. The computing system may have additional, less, or alternate functionality, including that discussed elsewhere herein.

In another aspect, a computer-implemented method for enabling collaborative interactions with a plurality of users in an extended reality collaboration environment is provided. The computer-implemented method may be implemented using one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ChatGPT or ChatGPT-based bots, and/or other electronic or electrical components, which may be in wired or wireless communication with one another. For example, in one instance, the computer-implemented method may be implemented using at least one processor and/or associated transceiver in communication with at least one memory device. The method may include: (i) communicating, via the one or more processors, with one or more user devices to cause the one or more user devices to present the extended reality collaboration environment including a personalized avatar of a first user associated with a first user device of the one or more user devices, wherein the extended reality collaboration environment corresponds to a real-time representation of a physical space; (ii) receiving, via the one or more processors, sensor data from a sensor including data representing the physical space, the sensor data comprising sensor data from at least one of: a camera, a microphone, a motion sensor, an environmental sensor, and other sensor devices configured to capture real-time and/or historical aspects of the physical space; (iii) generating, via the one or more processors, the extended reality collaboration environment corresponding to the physical space based at least upon the received sensor data, wherein the extended reality collaboration environment comprises a virtual representation of the physical space with the personalized avatar of the first user; (iv) receiving, via the one or more processors, user sensor data from the first user device, the user sensor data corresponding to user inputs from the first user device; (v) enabling, via the one or more processors, an interaction between the first user and the physical space within the extended reality collaboration environment on the user inputs from the first user device; and (vi) presenting, via the one or more processors, the interaction between the first user and the physical space within the extended reality collaboration environment on the one or more additional user devices. The computer-implemented method may have additional, less, or alternate functionality, including that discussed elsewhere herein.

In another aspect, at least one non-transitory computer-readable media having computer executable instruction embodied thereon for collaborative interactions between virtual and real-world environments using an extended reality collaboration environment is provided. The instructions may be executed using one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ChatGPT or ChatGPT-based bots, and/or other electronic or electrical components, which may be in wired or wireless communication with one another. For example, in one instance, the computing system may include at least one processor and/or associated transceiver in communication with at least one memory device. The at least one processor may execute the instructions, the computer-executable instructions cause the at least one processor to: (i) communicate with one or more user devices to cause the one or more user devices to present an extended reality collaboration environment including a personalized avatar of a first user associated with a first user device of the one or more user devices, wherein the extended reality collaboration environment corresponds to a real-time representation of a physical space; (ii) receive sensor data from a sensor including data representing the physical space, the sensor data comprising sensor data from at least one of: a camera, a microphone, a motion sensor, an environmental sensor, and other sensor devices configured to capture real-time and/or historical aspects of the physical space; (iii) generate the extended reality collaboration environment corresponding to the physical space based at least upon the received sensor data, wherein the extended reality collaboration environment comprises a virtual representation of the physical space with the personalized avatar of the first user; (iv) receive user sensor data from the first user device, the user sensor data corresponding to user inputs from the first user device; (v) enable interaction between the first user and the physical space within the extended reality collaboration environment on the user inputs from the first user device; and (vi) present the interaction between the first user and the physical space within the extended reality collaboration environment on the one or more additional user devices. The computer-executable instructions may have additional, less, or alternate functionality, including that discussed elsewhere herein.

In another aspect, a computing system for generating a virtual reality replicant persona for interaction with at least one user within an extended reality collaboration environment may be provided. The computing system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ChatGPT or ChatGPT-based bots, and/or other electronic or electrical components, which may be in wired or wireless communication with one another. For example, in one instance, the computing system may include at least one processor and/or associated transceiver in communication with at least one memory device and in communication with a user computing device associated with a user and with an interface of user computing device associated with a virtual user. The at least one processor may be programmed to: i) communicate with one or more user devices to cause the one or more user devices to present the extended reality collaboration environment including a personalized avatar of a first user associated with a first user device of the one or more user devices, wherein the extended reality collaboration environment corresponds to a real-time representation of a physical space, ii) receive sensor data from a sensor including data representing the physical space, the sensor data comprising sensor data from at least one of: a camera, a microphone, a motion sensor, an environmental sensor, and other sensor devices configured to capture real-time and/or historical aspects of the physical space, iii) generate the extended reality collaboration environment corresponding to the physical space based at least upon the received sensor data, wherein the extended reality collaboration environment comprises a virtual representation of the physical space with the personalized avatar of the first user, iv) receive user sensor data from the first user device, the user sensor data corresponding to user inputs from the first user device, v) enable interaction between the first user and the physical space within the extended reality collaboration environment on the user inputs from the first user device, and/or vi) present the interaction between the first user and the physical space within the extended reality collaboration environment on the one or more additional user devices. The computing system may have additional, less, or alternate functionality, including that discussed elsewhere herein.

In another aspect, a computer-implemented method for generating a virtual reality replicant persona for interaction with at least one user may be provided. The computer-implemented method may be implemented via one or more local or remote processors, servers, transceivers, sensors, memory units, mobile devices, wearables, smart watches, smart contact lenses, smart glasses, augmented reality (AR) glasses, virtual reality (VR) headsets, mixed reality (MR) or extended reality glasses or headsets, voice bots or chatbots, ChatGPT or ChatGPT-based bots, and/or other electronic or electrical components, which may be in wired or wireless communication with one another. For example, in one instance, the computer-implemented method may be implemented by a computing system including at least one processor and/or associated transceiver in communication with at least one memory device and in communication with a user computing device associated with a user and with an interface of user computing device associated with a virtual user. The method may include: i) communicating with one or more user devices to cause the one or more user devices to present the extended reality collaboration environment including a personalized avatar of a first user associated with a first user device of the one or more user devices, wherein the extended reality collaboration environment corresponds to a real-time representation of a physical space, ii) receiving sensor data from a sensor including data representing the physical space, the sensor data comprising sensor data from at least one of: a camera, a microphone, a motion sensor, an environmental sensor, and other sensor devices configured to capture real-time and/or historical aspects of the physical space, iii) generating the extended reality collaboration environment corresponding to the physical space based at least upon the received sensor data, wherein the extended reality collaboration environment comprises a virtual representation of the physical space with the personalized avatar of the first user, iv) receiving user sensor data from the first user device, the user sensor data corresponding to user inputs from the first user device, v) enabling interaction between the first user and the physical space within the extended reality collaboration environment on the user inputs from the first user device, and/or vi) presenting the interaction between the first user and the physical space within the extended reality collaboration environment on the one or more additional user devices. The method may include additional, less, or alternate actions, including those discussed elsewhere herein.

In yet another aspect, at least one non-transitory computing-readable media having computing-executable instructions embodied thereon may be provided. The computing-executable instructions may be executed by a computing system including at least one local or remote processor and/or associated transceivers in communication with at least one local or remote memory device and in communication with a user computing device associated with a user and with an interface of user computing device associated with a virtual user. The computing-executable instructions may direct or cause the at least one processor to: i) communicate with one or more user devices to cause the one or more user devices to present the extended reality collaboration environment including a personalized avatar of a first user associated with a first user device of the one or more user devices, wherein the extended reality collaboration environment corresponds to a real-time representation of a physical space, ii) receive sensor data from a sensor including data representing the physical space, the sensor data comprising sensor data from at least one of: a camera, a microphone, a motion sensor, an environmental sensor, and other sensor devices configured to capture real-time and/or historical aspects of the physical space, iii) generate the extended reality collaboration environment corresponding to the physical space based at least upon the received sensor data, wherein the extended reality collaboration environment comprises a virtual representation of the physical space with the personalized avatar of the first user, iv) receive user sensor data from the first user device, the user sensor data corresponding to user inputs from the first user device, v) enable interaction between the first user and the physical space within the extended reality collaboration environment on the user inputs from the first user device, and/or vi) present the interaction between the first user and the physical space within the extended reality collaboration environment on the one or more additional user devices. The computing-executable instructions may direct additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures may be intended to accord with a possible embodiment thereof. Further, wherever possible, the following description refers to the reference numerals included in the following Figures in which features depicted in multiple Figures are designated with consistent reference numerals.

There are shown in the drawings arrangements which are presently discussed herein. However, it should be understood that the present embodiments are not limited to the precise arrangements and/or instrumentalities shown herein.

FIG. 1 illustrates a schematic diagram of an exemplary extended reality computing system for interaction with at least one user in an extended reality collaboration environment according to an exemplary embodiment of the present disclosure.

FIG. 2 illustrates a simplified block diagram of an exemplary computing system for use with the exemplary extended reality computing system shown in FIG. 1.

FIG. 3 illustrates an exemplary instructional exercise including an extended reality collaboration environment for use with the exemplary extended reality computing system shown in FIG. 1.

FIG. 4 illustrates an exemplary configuration of a user computing according to an exemplary embodiment of the present disclosure.

FIG. 5 illustrates an exemplary configuration of an extended reality computing device according to an exemplary embodiment of the present disclosure.

FIG. 6 illustrates a flow chart of an exemplary computer-implemented process for interaction with at least one user in an extended reality collaboration environment according to an exemplary embodiment of the present disclosure.

FIG. 7 is a continuation of the flow chart illustrated in FIG. 6.

FIG. 8 illustrates a flow chart of an exemplary computer-implemented process for generating an avatar for a virtual user or other individual according to an exemplary embodiment of the present disclosure.

FIG. 9 depicts a flow chart of an exemplary computer-implemented process for providing a secure data exchange in an extended reality collaboration environment such as the extended reality collaboration environment described as an exemplary embodiment of the present disclosure.

FIG. 10 depicts a flow chart of an exemplary computer-implemented process for providing real time instructional recommendations in an extended reality collaboration environment described as an exemplary embodiment of the present disclosure.

FIG. 11 depicts a flow chart of an exemplary computer-implemented process for generating a virtual guide during an instructional exercise.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

As described herein, a replicant persona may be, inter alia, an artificial intelligence (AI) driven digital recreation of an individual, such as, but not limited to, virtual users, physical space user, and/or additional users of an extended reality (XR) environment. These replicant personas may include real and fictional human or non-human individuals. The replicant persona may be trained to simulate a personality of an individual including replicating the traits of the individual including, but not limited to, their mannerisms, appearance, personality, historical and conversational talking points of an actual, real-life person.

Also, as described herein, an avatar may be an audio and/or visual representation of the individual being controlled by the replicant persona. In the exemplary embodiment, an avatar may be used to interact with extended reality collaboration environment users, in particular, a physical space user and a virtual user, within in an extended reality environment. In some embodiments, there may be multiple avatars for the same replicant persona. For example, multiple avatars for an individual may be in multiple locations in the extended reality environment.

In the exemplary embodiment, an avatar may be connected to or controlled by the replicant persona, where the replicant persona controls the actions and reactions of the individual avatars. For example, if a question may be asked of the avatar, the question may be routed to the replicant persona, which formulates a response and transmits the response to the avatar. In some embodiments, a single replicant persona may control multiple avatars simultaneously. In some examples, an avatar may be performing as a virtual user to instruct a physical space user in selling an insurance policy and/or other products, receive and/or process insurance claims, conduct a meeting, and/or provide information and/or answer general insurance-related questions within the extended reality environment. In other words, an avatar associated with a replicant persona may be a virtual user or physical space user avatar and may sell insurance and/or other products to a user, directly, or via a user avatar as described below.

For the purposes of this discussion, a user avatar may be an audio and/or visual representation of a user that may be directly controlled by that user within an extended reality environment. In some embodiments, the user avatar may be controlled via the user computing device as the user may be logged into the virtual reality environment. Additionally, or alternatively, the user avatar may be controlled based on sensor data captured in the physical space corresponding to the extended reality environment. In some embodiments, the user avatar may be a direct representation of the user. In other embodiments, the user avatar may be anything that the user wishes to be within the virtual reality embodiment. The user may be able to modify their user avatar to change its appearance, such as by changing the appearance, clothing, hairstyle, and other attributes of the user avatar. In some embodiments, a user avatar may be associated with an account of the user. In some of these embodiments, the user may have more than one account and therefore multiple user avatars. In some further embodiments, the user may have multiple user avatars associated with their account and use different ones at different times.

As used herein, “Virtual reality environment” or “VR environment” refers to a digital or virtual environment experienced by or displayed to a user through a VR (virtual reality) computing device. In other words, “VR environment” refers to the VR view and functionality experienced by a user through a VR enabled computing device. Conversely, any virtual or digital environment displayed to a user through a VR computing device may be considered a VR environment.

As used herein, “AR environment” refers to a digital or extended reality collaboration environment overlaid on a real-world environment and experienced by a user through a VR/AR (Augmented Reality) computing device. In other words, “AR environment” refers to the AR display and functionality experienced by a user through an AR enabled computing device. Mixed or extended reality (XR) devices may also be used for input and/or output.

In some further embodiment, the VR and/or AR may allow for haptic responses to allow the user to feel an interaction with an object. The haptic response may be provided through the use of gloves or other feedback devices. In one embodiment, the haptic response allows the user to feel the texture of the 3-D object and/or the weight of the 3-D object. For example, the user may shake the avatar's hand or receive a virtual object from the avatar, and the user would be able to feel the handshake, or the object being handed to the avatar.

The present embodiments may relate to, inter alia, systems and methods for enhanced extended reality interactions. In the exemplary embodiment, the systems and methods may generate an extended reality collaboration environment that includes (1) one or more avatars and/or (2) one or more extended reality locations that may be visited by a user avatar controlled by a user with a user computing device (e.g., an AR or VR headset and/or other AR or VR system). These extended reality locations may include places of business, such as offices or stores or other locations, having real-world counterparts, and may be occupied by user avatars (e.g., if the virtual user may be available live) and/or avatars associated with a replica persona of the user (e.g., if the user may be not available live). In some cases, a virtual location or an extended reality location is based upon an actual geographic location. By linking the virtual locations to a physical space, the user may interact with users associated with the physical space using the extended reality system, for example, by viewing overlays or aspects of the extended reality collaboration environment itself (e.g., virtual signage or documents included in the extended reality collaboration environment) and/or by interacting with a corresponding user (e.g., by asking questions and receiving responses from the virtual user or the physical space user).

By visiting and interviewing virtual users in an extended reality setting, the user does not need to physically travel to interact with different users, therefore making it easier for users in remote locations to interact with one or more users present in the physical space, and also making it easier for users present within the physical space to communicate with the virtual user. For example, by visiting one or more extended reality environments, virtual users can interact with various physical spaces without having to travel.

Additionally, data provided by the physical user or virtual user may be recorded and stored in a database, so that the data may be retrieved seamlessly for future interactions within the extended reality collaboration environment or the extended reality environment computing system, e.g., to evaluate the interactions of the physical space user and/or the virtual user. Additionally, data collected from the extended reality collaboration environment may also be used for traditional interactions outside of the extended reality collaboration environment. For example, records of interactions within the extended reality collaboration environment may be used to process any transactions that may have occurred within the extended reality collaboration environment.

The system may further provide a secure exchange of documents and/or other data using a virtual file cabinet for storing documents. The virtual file cabinet may enable a user to securely store actual or sample documents and to authorize other users to access the documents. For example, an virtual user may, through input (e.g., within the extended reality collaboration environment, a mobile app, and/or web page) designate documents (e.g., recommendation messages, presentations, documents, and/or documents and/or other data relating to insurance claims) to be stored in the virtual file cabinet, or the documents may automatically be stored in association with the virtual file cabinet in response to certain interactions (e.g., an interaction triggering a presentation, purchase or renewal of an insurance policy and/or filing of an insurance claim). The user may also designate other users (e.g., virtual users, physical space users, or other individuals associated with the extended reality collaborative environment) to access any of these stored documents, or the system may determine which individuals to authorize for access. These authorized users may than retrieve, view, and/or trigger a download of these documents, for example, by accessing the virtual file cabinet within the extended reality collaboration environment.

In embodiments in which the virtual file cabinet includes insurance-related documents, this access to the virtual file cabinet enables the authorized users to access those documents in real time. It should be noted that access to the virtual file cabinet may further include access to certain documents included within the virtual file cabinet. In other words, a blanket or broad access may be given to a certain user by the authorized user so that that the broad access user may be able to see and access all documents included within the virtual file cabinet. In another case, a user may be given limited or targeted access to a specific set of documents included in the virtual file cabinet, and that limited access user would only be able to see and access those documents.

The system may further provide for a real time interaction between a physical space user and a virtual user in the extended reality collaboration environment. The system may provide guidance and/or information to the user via a user computing device, for example, as messages displayed within the extended reality collaboration environment and/or instructions provided by a virtual guide. The virtual guide may be AI driven. These messages may include text or speech (e.g., speech associated with the virtual guide described above). The message may include documents including a script (e.g., a teleprompter) for display to both the physical space user and the virtual user. In another example, the message may instruct the user on how to navigate the extended reality collaborative environment to interact with an additional user. The user computing device may also passively collect data, such as image and/or audio data to generate a historical interaction record which may be used to evaluate extended reality collaborative environment interaction.

In some embodiments, the collected information during an instructional exercise may be used to determine if additional resources, such as emergency personnel or insurance personnel, need to be contacted, and automatically initiate such contact (e.g., by initiating a virtual and instructional emergency “9-1-1” call and/or presenting an virtual user avatar within the extended reality collaboration environment as described above). The collected information may further be used to generate digital twins, simulations, and/or visual reconstructions of an actual geospatial environment, which may be used to determine an extent of damage or injury that has occurred and the cause of an incident, such as an interaction, vehicle or otherwise, a hail store, a hurricane, a fire, a flood, etc. These reconstructions may be viewed within the extended reality collaboration environment by the physical space user, the virtual user and/or an additional user.

### Providing User Interations in an Extended Reality Collaboration Environment

In the exemplary embodiment, the extended reality computing system may communicate with a user computing device to cause the user computing device to present the extended reality collaboration environment. In embodiments described herein, users may refer to any person, or virtual person representation, interacting with the extended reality collaboration environment, such as a virtual user, a physical space user, and/or additional users. The system may provide video data, audio data, or other data (e.g., haptic feedback data) that may be presented to the user by the user computing device, e.g., presented to the virtual user. The system may receive user input data such as live audio data, live video data, or live motion data from the user computing device, and based upon this received user input data, the system may continually update the extended reality collaboration environment. Further, the extended reality collaboration environment may receive user input data from sensors associated with the physical space. For example, the system may respond to motion, voice commands or other speech, and/or other input (e.g., facial expressions) of the user. In some embodiments, if the system determines that the user may be visiting a location within the extended reality collaboration environment based upon the input data, a physical space user or other individual associated with the location may receive a notification.

In the exemplary embodiment, the system may generate a recommendation to a user based upon received user input data. User input that indicates a response may be required may include questions input by the user (e.g., as voice or text) or other actions by the user. For example, if the user (e.g., the virtual user or physical space user) may not be talking but has a confused facial expression, the system may be triggered to determine information or some other assistance (e.g., one or more recommendations) to offered to the user (e.g., to guide the user in their interaction with the additional users). The recommendation may include a proposed response including information to provide the user (e.g., specific language to speak to the additional users, documents to provide to the additional users, or interactions with the extended reality environment to enable interaction with the additional users). The system may be triggered to generate the recommendations based on motions or gestures to be performed by the user, or other actions associated with the extended reality environment. In some embodiments, the system may be triggered to generate the recommendation by any satisfied suitable criterion, referred to herein as an instructional incident.

In some embodiments, these recommendations may include actions outside of the extended reality collaboration environment, such as sending emails, phone messages, and/or text messages (e.g., to the physical space user or the virtual user). Additional or alternative actions may be executed outside of the extended reality collaboration environment. For example, if the additional users agree to a commitment within the extended reality collaboration environment, the system may transmit documents for the additional users to subsequent to the interaction in the extended reality collaboration environment. In some embodiments, transmission of these documents may be triggered by analogous actions in the extended reality collaboration environment, such as by dropping a document into a virtual mailbox. In certain embodiments, these actions may include real-time binding offers or quotes (e.g., insurance quotes) to which the users may accept within the extended reality collaboration environment. These may be generated based upon data provided by the users within the extended reality collaboration environment and/or other retrieved data about the user (e.g., from a user profile and/or other web sources or databases accessible by the system). Any input from the user may be recorded by the system to enable such interactions to be processed and referred to in the future.

When the extended reality computing system generates a recommendation, the system may determine whether a virtual user, physical space user, or any additional users may be present within the extended reality collaborative environment (e.g., using a user computing device and/or an VR or AR headset through which the virtual user may control a respective avatar). For example, the system may determine whether the virtual user, physical space user, or additional users may be logged in and/or has interacted with the extended reality environment within a threshold period of time. When the virtual user, physical space user, or additional users may be present within the extended reality collaboration environment, the system may cause an interface to display a recommendation for further interaction with the extended reality environment. For example, the recommendation may be displayed as an overlay within the extended reality collaboration environment visible to at least one of the users, although the message may not be visible to some of the other users accessing the extended reality collaboration environment. In some embodiments described herein, the recommendation may describe the state of the additional users, providing the user with valuable feedback during interactions with additional users and facilitating collaboration between the users in the extended reality collaboration environment.

In these cases, the recommendations may direct either the physical space user, or the virtual user, on how they can interact within the extended reality collaborative environment. For example, if the system determines the additional users may be becoming confused during an interaction, the generated recommendations may direct the user to slow down and/or offer additional explanation. These recommendations may be generated using one or more chatbots and/or using AI programs such as ChatGPT. In certain embodiments, if the additional users and user speak different languages, the system may provide translation in real time.

In the exemplary embodiment, when the user (e.g., the virtual user) is not present at their user computing device (e.g., not present at an interface of the user computing device) interface, the extended reality computing system may cause at least one avatar associated with the user to interact with the extended reality collaborative environment based upon a replicant persona associated with the user. In such cases, the avatar may replicate the traits of the user including, but not limited to, the mannerisms, appearance, personality, historical and conversational talking points. Actions or responses of the replicant persona may be generated using one or more chatbots and/or using AI programs such as ChatGPT. Accordingly, the avatar may act as a surrogate for the user when the user is not present or is unavailable, with the avatar interacting with physical space user to support interactions within the extended reality collaboration environment without being burdensome to the additional users.

In some embodiments, for example, the extended reality collaboration environment may present an extended reality collaboration environment based on historical interactions between the users, and as such, the extended reality collaboration environment may support an AI generated avatar of at least one of the users. Likewise, the extended reality collaboration environment may support an AI generated avatar of a user that may be currently present at the interface of the virtual user computing device.

For instance, a replicant persona for a user may be created and stored. When a user (e.g., a physical space user or a virtual user) in an extended reality environment walks into the extended reality collaboration environment (e.g., a business, a residential location, a classroom, etc.), the user may be greeted by an avatar of the virtual user that can answer questions or introduce the user to the extended reality collaboration environment. In some embodiments, a new avatar (e.g., each representing a user) may be generated to interact with each additional user. These could be multiple user avatars each connected to different personas or multiple avatars with the same persona. Therefore, multiple users could be interacting with their own version of the avatar of the same user, simultaneously. This allows the extended reality computing system to provide a personal, singular engagement with physical additional users, enabling physical user interactions with the extended reality environment to be customized to the user, e.g., the historical behavior or prior performance of the user during other historical interactions.

In a further example, a user avatar generated to interact with an additional user may be trained to interact with the additional user within the extended reality environment in accordance with certain traits of the user that are learned through virtual or actual interaction with the user. In one example, the traits of the user may include the user's body language, the user's speaking accent and/or dialect observed from an initial interaction (real or virtual) with the user for a specific period (e.g., initial 5 minutes or 10 minutes). Additionally, or alternatively, the traits of the user may be retrieved from a database in which the user's profile and the traits of the user are stored.

In some embodiments, the avatar of the user or the additional user may be interacting with the additional user to sell a new product or service (e.g., insurance products) for the additional user's newly purchased home or vehicle, or the avatar may be interacting with the additional users for a meeting with the additional users for an interaction. Accordingly, the user or additional users' avatar may be trained to show emotion based on the context of the interaction. The emotions displayed by the avatar may include empathy, excitement, joy, kindness, or some other emotion that may be appropriate with the cause of the interaction with the additional user. Additionally, or alternatively, the avatar may display certain traits or mannerisms using the avatar that represent the user or additional users, which may help to increase the user's confidence during the interaction. In some cases, those traits or mannerisms incorporated into the avatar may include similar traits and mannerism expressed by the user or additional users.

In certain embodiments, a live user may initially control the avatar, for example, to respond to or greet the additional user, and/or to interact with the additional user to provide answers or information to the additional users. However, based upon the monitoring of the interaction between the avatar being controlled by the real user, if it may be determined that the interaction may be not meeting a specific criterion, for example, the user's interactions with the additional user are not generating the desired responses or feedback from the user, the avatar may be controlled by an artificial intelligence (AI) model or a machine-learning model to meet the specific criterion. For example, the user may be having a bad day, and, therefore, may be unable to show an appropriate level of empathy towards the additional user during an interaction or the user may be unable to explain a concept in a clear manner such that either, or both, of the user and additional user may be becoming frustrated. Upon detecting such a condition or feedback from the user or additional user, the system may control the avatar via the AI model or the ML model to adjust the level of empathy and/or reexplain concepts to the additional user. Conversely, if may be determined that a computer-controlled avatar may be a missing a specific criterion, the system may alert a live user to take control of the avatar to assist in the interaction.

In some examples, based upon a user profile of the user or historical interactions with the user, if it may be determined that the user has a specific accent or dialect associated with a specific geographic location, the avatar may interact with the other user using the specific accent or dialect. If it may be learned that the user frequently uses jokes, or one-liners while interacting, the avatar may be trained to use similar behavior while interacting with the other user, which may be likely to increase a comfort level of the other while interacting with a user's avatar.

In addition, using one or more sensors (e.g., a biometric sensor, microphone and/or a camera), the user's facial gestures, hand gestures, body language, and so on, may be recorded (e.g., while the user may be controlling the avatar live) and used for training the avatar to interact with the additional user in a specific way to facilitate the interaction with the additional user. An artificial intelligence (AI) model or a machine-learning (ML) model may be used to train the avatar to identify which traits of the user are beneficial to mimic or reproduce to increase the additional user's trust and confidence, and/or which traits of the user may not be used by the avatar. The AI or ML model may also be used to train the avatar to use empathy during the interaction with the additional user avatar. For example, if the additional user may be frustrated and/or may be confused regarding how to communicate with the user, the user avatar may use a kind or slow cadence to explain to the additional user the specific details of the information.

The replicant persona, based upon which the avatar may be controlled, may be generated using one or more of Deep/Machine Learning (ML), Natural Language Processing (NLP), Voice Intelligence, and Artificial Intelligence (AI) to digitally replicate physical features and personality traits, mannerisms, voices, conversational style, quirks, interactions, facial expressions, hand gestures and/or other visible or audible mannerisms, and historical data and roles of the user. The replicant persona may be then used to generate one or more avatars to create unique and personalized experiences for users in a virtual reality or augmented reality space, such as the extended reality environment.

Data used to develop this replicant persona may include, but may not be limited to, all available interactions from movies, videos, social media posts, interviews, recordings, images, scripts, other sources where a person's (e.g., a user's) true personality and style could ultimately be captured, and/or current or historical interactions with the user. These data points could then be synthesized by deep/machine learning and cognitive computing and AI Voice subfields to accurately represent the user and how they might respond given certain inputs and scenarios while interacting with the additional user.

The replicant persona can be used to generate individual avatars for different interactions. In some further embodiments, the individual avatar may be loaded with or have access to information about the individual user that the avatar may be interacting with. For example, the avatar may know the user's name and call them by name directly. In a business interaction, the avatar may know additional information about the user, up to and including account details and/or other private or personally identifiable information.

In some embodiments, where the person (e.g., user) to be represented by the avatar may be available, the system may use a 3-D indexing tool to scan the user. The 3-D indexing tool may scan and capture the physical essence of the user including, but not limited to physical attributes, tattoos, hair style, make-up, clothing, and other interesting aspects of the virtual user to use with an avatar that interacts with the user. In various embodiments, the 3-D indexing tool may be integrated into the user computing device or the physical space associated with the extended reality environment.

In some examples, a user may use his/her user avatar to interact with the extended reality collaboration environment, including interacting with other user avatars in the environment. While a user avatar represents the individual user on a one-to-one basis, a replicant persona can have multiple avatars executing simultaneously in different areas of the extended reality collaboration environment. For example, a first user may be in a room with a first avatar of the replicant persona, while a second user may be in a separate room with a second avatar of the same replicant persona. The first user and the second user are able to separately and simultaneously interact with their own avatar of the replicant person.

The use of Virtual Reality (VR) and Augmented Reality (AR) for interacting with 3D avatars provides a new interface for interacting in new ways. VR and AR systems allow a user to interact with an extended reality collaboration environment in a new way compared to traditional interactions using a two-dimensional (2-D) display. In VR, a user may be immersed in an extended reality collaboration environment (e.g., using a VR headset). In other words, a VR device displays images, sounds, etc. to the user in a way that mimics how a user receives sensory stimuli in the real world. In AR, the user may be provided with digital data that overlays objects or environments in the real world (such as via AR glasses). AR devices may use a camera or other input to determine the objects in a user's line of sight and present additional digital data that compliments the real-world environment.

Examples of extended reality collaboration environments may include, but are not limited to, Minecraft® (Minecraft may be a registered trademark of Microsoft Corporation, Redmond, Washington), Metaverse, and Second Life® (Second Life may be a registered trademark of Linden Lab of San Francisco, CA). These extended reality collaboration environments allow the user to interact with and modify said environments using VR tools, such as by building and creating content including structures and objects.

As described in further detail herein, VR and AR technologies may be utilized to more effectively interact with avatars. In one embodiment, a user interacts with an avatar using VR. Specifically, the user navigates to an extended reality collaboration environment, applying bounding frames to objects, labeling objects, rotating views, and traversing areas of the extended reality collaboration environment using a VR device. The user also interacts with individual avatars in the extended reality collaboration environment.

These avatars may be other users with their user avatars or avatars controlled by replicant personas as described herein. In other words, the user may be immersed in an extended reality collaboration environment and interact with the extended reality collaboration environment through the VR device in order to interact with and/or view 3D objects and avatars.

In one embodiment, the extended reality collaboration environment may be a recreation and/or representation of a place of business and the user interacts with avatars in the place of business to conduct transactions with the business. Additionally, the extended reality virtual environment may mirror a corresponding physical space, allowing the user to influence and interact with real-world objects and systems, to facilitate seamless integration between the virtual and physical environments. The connection provided by the extended reality environment improves operational efficiency, enabling users to perform tasks in the virtual environment that directly impact or manipulate the physical space.

In another embodiment, a user views a real-world environment, and an AR device displays virtual content overlaying the real-world environment. Specifically, if the user may be in a geographic location associated with the geographic location of an avatar, the AR device may overlay the real-world environment with the avatar from the 3D digital environment, allowing the user to interact with the digital environment and digital objects. For example, the user may be in a place of business, and the user may receive information about the business or its products as an overlay.

### Providing Secure Data Exchange in an Extended Reality Collaboration Environment

In the exemplary embodiments described herein, a virtual guide may be provided to the users. The virtual guide provided to the user within the extended reality collaboration environment may include AI generated or pre-saved virtual guides. In some embodiments, the virtual guides are provided to the physical space user and the users avatar may be AI generated, e.g., during an initial phase before the user interacts with the additional users. However, some virtual guides may be provided to the additional users, while enabling supervision provided by the collaboration system. For example, physical space users and virtual users may be provided virtual guides by the collaboration system.

As such, the collaboration system may also be enabled to provide real-time support for the additional users including secure or encrypted exchange of sensitive user data. For example, in the exemplary embodiment, the system may provide a secure exchange of documents and/or other data using a virtual file cabinet mechanism.

The virtual file cabinet may enable a user to securely store documents and to authorize other users to access the documents. For example, the virtual user may, through input (e.g., within the extended reality collaboration environment, a mobile app, and/or web page) designate documents (e.g., extended reality collaboration environments, scripts, sensor data, insurance policy documents, insurance cards, and/or documents and/or other data relating to the interaction and/or to insurance claims) to be stored in the virtual file cabinet, or the documents may automatically be stored in association with the virtual file cabinet in response to certain interactions (e.g., triggering of an interaction, purchase or renewal of an insurance policy and/or filing of an insurance claim).

The user may also designate other users (e.g., virtual users, physical space users, or other additional users) to access any of these stored documents, or the system may determine which individuals to authorize access to certain documents stored within the virtual file cabinet. These authorized users may than retrieve, view, and/or trigger a download of these documents, for example, by accessing the virtual file cabinet within the extended reality collaboration environment. In embodiments in which the virtual file cabinet includes insurance-related documents, such access enables authorized users to quickly access these documents and determine insurance coverage in real time in case of an interaction or other insurance-related interaction.

In the exemplary embodiment, the system may be configured to communicate with one or more user computing devices to cause those user computing devices to present the extended reality collaboration environment to include at least one virtual file cabinet associated with a first user. In certain embodiments, the virtual file cabinet may appear similar to an actual file cabinet or any other item (e.g., a safe or a file cabinet) users would likely understand to indicate a secure place to store documents. Alternatively, the virtual file cabinet may appear as any other type of item, point, or node within the extended reality collaboration environment labeled as such (e.g., an icon or button).

As described above, each user may have a corresponding user avatar, which may interact with the virtual file cabinet within the extended reality collaboration environment analogously to how a person may interact with a file cabinet in real life (e.g., opening or closing and/or depositing or withdrawing documents). As described in further detail below, access to and/or the appearance of the file cabinet to a particular user may be controlled based upon whether the particular user may be authorized to access any documents stored in the virtual file cabinet.

Within the extended reality collaboration environment, the virtual file cabinet may include and/or be labeled with text or indicators providing information about the virtual file cabinet (e.g., which user may be associated with the file cabinet, a relationship between the viewer and the user may be associated with the file cabinet, and/or whether the viewer has access to any documents in the virtual file cabinet). For example, the file cabinet may include a lock that requires a combination or code to be entered to allow a user to access documents included within the file cabinet. A different code may be tied to the different documents included with in the virtual file cabinet such that when a code may be entered only the documents linked to that code are shown and are accessible by that user.

In the exemplary embodiment, the system may be configured to store one or more documents in the memory in association with the virtual file cabinet. For example, the user may designate documents to store in association with the virtual file cabinet or the system may automatically determine and store, or suggest storing, documents in association with the virtual file cabinet.

In certain embodiments, the user may input instructions at a mobile device via mobile application instructions to store documents in associated with the at least one virtual file cabinet. The system may then store the one or more documents in association with the at least one virtual file cabinet in response to receiving the instruction. Additionally, or alternatively, the user may generate user input data (e.g., by making corresponding movements and gestures) with the user computing device that indicates an intention to store the one or more documents in association with the virtual file cabinet (e.g., dragging and placing, or selecting from a menu). The system may then store the one or more documents in association with the virtual file cabinet in response to receiving this user input data.

In some embodiments, the system may automatically identify documents to store. For example, the system may identify any insurance policy instruction document, insurance cards, and/or insurance claim documents that are associated with the user and may automatically store the documents or generate interaction recommendations for the user to store the documents in the virtual file cabinet.

In the exemplary embodiment, the system may be configured to identify one or more authorized users of the plurality of users to enable access to the at least one virtual file cabinet. The user associated with the file cabinet may select other users to receive authorization. For example, the user may submit instructions at the mobile device via the mobile application instructions to designate one or more users as authorized to access the one or more documents, and the system may identify one or more authorized users based upon the received instruction. The user may submit similar instructions through another channel, such as through interaction within the extended reality collaboration environment itself and/or through another computing device.

Additionally, or alternatively, the system may automatically determine who should have access to the virtual lock box. For example, the system may identify any virtual users associated with the user and/or any other individuals involved in claims submitted by the user (e.g., other parties of an interaction, other insurers, police officers, repair technicians, etc.) as authorized to access one or more of the documents stored in association with the virtual file cabinet.

In the exemplary embodiment, the system may be configured to provide access to the one or more documents in response to the identified one or more authorized users interacting with the virtual file cabinet in the extended reality collaboration environment. For example, the authorized users may open, click, or tap on, or otherwise interact with the virtual file cabinet in the extended reality collaboration environment, which may enable the authorized users to view of download the documents. Additionally, or alternatively, the documents may be viewed within the extended reality collaboration environment. Additionally, or alternatively, accessing the documents in the extended reality collaboration environment may trigger a download or other transfer of data that enables the documents to be viewed through a different channel, such as through the mobile app, web page, and/or another type of file-viewing application.

### Providing Virtual Guide to User Interacting with Additional Users in Extended Reality Collaboration Envirinment

In the exemplary embodiment, the system may provide a virtual guide for the user interacting with additional users within the extended reality collaboration environment. The virtual guide may be an AI driven virtual guide. The system may receive sensor data from the user computing devices (e.g., data captured by smart glasses or biometric devices), which may be used to determine if an interaction (e.g., an interaction) has occurred. In response to detecting an interaction and/or receiving input from the user (e.g., as a voice command) that an interaction has occurred, the system may prompt the user to interact with a live virtual user and/or replicant persona in the extended reality collaboration environment as described above.

The virtual guide may be associated with an assistant that provides information, recommendations, and/or feedback to the users, as the users navigate the extended reality collaboration environment. For example, the virtual guide may suggest conference rooms suitable for the number of users participating in the extended reality collaboration environment or suggest tools (whiteboard, slide show, lighting controls, etc.) or collaboration elements that may be useful during participation in the extended reality collaboration environment.

The system may provide guidance and/or instructions to the user via the user computing device, for example, as prompts are displayed within the extended reality collaboration environment and/or instructions provided by a user avatar. These messages may include text or speech (e.g., speech associated with the avatars described above). The messages may include questions verifying information about the user or to provide information about the interaction. For example, the prompts may instruct the user to take pictures and/or ask questions to others present within the scene of the interaction.

The user computing device may also passively collect data, such as image and/or audio data, in response to the interaction being detected. This collected information may be used to determine if additional resources are needed to facilitate the interaction in the extended reality collaboration environment. The collected information may further be used to generate digital twins, simulations, and/or visual reconstructions of the interaction, which may be used to determine what occurred during the interaction. In certain embodiments, these reconstructions may be viewed within the extended reality collaboration environment.

In the exemplary embodiment, the system may be configured to receive sensor data from the user computing devices. For example, at least some of the user computing device may include cameras, microphones, motion sensors (e.g., accelerometers and/or gyroscopes), location sensors (e.g., GPS), radar, and/or lidar. User computing devices may also include biometric sensors, including for example and without limitation, heart rate sensors, oxygen, or CO2 sensors, a stress sensor (e.g., continuous electrodermal activity (cEDA) sensors), temperature sensors, blood pressure sensors, and/or sweat sensor (e.g., epidermal optic sensors). The user computing devices may include any other types of sensors. This data may be received (e.g., continuously, or periodically) prior to, during, and following an interaction. As described in further detail below, this senor data may be used by the system to determine when an interaction has occurred and to gather information about the nature, scene, context, and results of the interaction.

In the exemplary embodiment, the system may be further configured to determine, based upon the received sensor data, that an interaction has occurred. In certain embodiments, this determination may be made by analyzing audio, video, and/or motion data, for example, using AI and/or machine learning techniques and/or by comparing such data to one or more predefined thresholds indicative that an interaction has occurred (e.g., determining the presence of a user and an additional user in the extended reality collaboration environment).

The determination may be made based upon detected voice, speech, facial expressions, and/or gestures made by the user or other individuals in the area. For example, in certain embodiments, the system may utilize specific voice commands or phrases made by the user (e.g., saying “in an interaction”) to determine an interaction has occurred and initiate an appropriate response. Additionally, or alternatively, the system may analyze non-structured speech or voice (e.g., using AI and/or chatbots) to determine that the non-structured speech or voice indicates an interaction has occurred. When it may be determined an interaction has occurred, the user may be alerted to launch or access the extended reality collaboration environment via the user computing device using voice commands.

In some embodiments, the system may be configured to detect one or more voice commands input by the first user to the first user computing device. As described above, some of these voice commands may relate to an indication that an interaction has occurred. Additionally, the voice commands may request specific actions, such as contacting a user (e.g., by saying “contact user”).

The system may analyze these voice commands (e.g., using AI and/or chatbots and/or by performing a lookup based upon the received speech) to determine an appropriate response. For example, saying “contact user” may bring the user, user machine learning bot/avatar or replicant persona, or other additional users into the extended reality collaboration environment for discussion or other interaction with the user. Additionally or alternatively, the system may present within the extended reality collaboration environment to a virtual user using a user device, a message to enable interaction with the user using the extended reality collaboration environment. As described above, the system may generate responses to be performed by avatars and/or recommended to users and/or the additional users and may retrieve relevant policy documents for review by the user.

In certain embodiments, the system may determine to perform these actions (e.g., contacting additional users) even without a specific voice command. For example, if the system determines with sufficient confidence that an interaction has occurred, the system may automatically contact additional users through an appropriate channel and/or provide relevant information (e.g., a location of the user and/or identities of persons involved).

In the exemplary embodiment, in response to determining the interaction has occurred, the system may be configured to present within the extended reality collaboration environment one or more messages for collecting information relating to the interaction using the user computing device. The prompts may be presented as text, audible commands, and/or statements made by avatars within the extended reality collaboration environment. Examples of such messages may include instructions to interact with the physical space associated with the user and/or interaction recommendations for the additional users within the extended reality collaboration environment. Additionally, or alternatively, these prompts may be generated using AI and/or chatbot technology, for example, to gather as much information as possible relevant to facilitate the interaction. The system may record interactions or other information resulting from the user following these instructions. The information captured during the interaction may be transmitted by the user computing device back to the system to be recorded and/or analyzed further.

In some embodiments, the system may automatically identify other individuals during the interaction. For example, the system may detect one or more devices proximate to the user computing device (e.g., using Bluetooth device identification and/or another appropriate form of wireless communication), and may perform a lookup to identify individuals present during the interaction based upon the detected one or more devices. Additionally, or alternatively, the system may identify individuals based upon detecting and analyzing voices of or statements made by the individuals detected by the user computing device.

In the exemplary embodiment, the system may be further configured to generate an interaction profile including the information collected by the user using the first user computing device in response to the interactions within the extended reality collaborative environment. The interaction profile may be a database, database component, and/or data structure that stores various types of information associated with the interaction. In addition to the sensor data and information gathered by the user associated with the interaction, other relevant data may be recorded in association with the interaction profile, such as a date, time, location, weather, traffic, maps, geographic models, or vehicle models, and/or other data associated with or providing context to the interaction. In certain embodiments, the system may retrieve additional information from sensors associated with the physical space that corresponds to the extended reality collaboration environment and store the data in association with the interaction profile.

In some embodiments, the system may generate one or more digital twins representing people, vehicles, or other objects involved in the interaction and/or a visual representation and/or reconstruction of the interaction based upon information included in the interaction profile. For example, the system may parse the interaction profile for sensor data, speech data, and/or documents relating to the interaction to identify positions and orientations of relevant people and objects during the course of the interaction. Additionally, or alternatively, AI and/or machine learning techniques may be utilized for such parsing. The visual representation may be presented within the extended reality collaboration environment, so that users or others reviewing the interaction may do so in a three-dimensional environment.

At least one of the technical problems addressed by this system may include: (i) improving interactions in between physical space users and virtual users using virtual reality by facilitating an interaction using the extended reality collaboration environment, e.g., a physical space user, a virtual user, and/or additional users, including the emotions of the user and the subject matter of the conversation during the interaction with the user; (ii) improving accuracy of artificial intelligence driven avatars in virtual reality; (iii) improving the ability for a user to navigate and interact with a physical space using a virtual guide in the extended reality collaboration environment; (iv) providing access to a physical space user for remote interactions with virtual users or additional users, in an environment simulating a face-to-face interaction; (v) facilitating an exchange of information through an extended reality collaboration environment by enabling recording interactions within the environment and triggering exchange of information through different channels in response to interactions within the extended reality collaboration environment; (vi) providing an ability to securely transfer documents and/or other data in a metaverse environment; (vii) providing instructional assistance and/or a script to be communicated in real-time during current interactions between physical space users and virtual users; and/or (viii) providing a user with information regarding the emotional state of the additional users to facilitate the interaction.

The computing-based or computer-implemented methods and computing systems described herein may be implemented (i) using computing programming or engineering techniques including computing software, firmware, hardware, or any combination or subset thereof, and/or (ii) by using one or more local or remote processors, transceivers, servers, sensors, servers, scanners, AR or VR headsets or glasses, smart glasses, wearables, smart watches, dermal patches, mobile devices, laptops, video game systems, and/or other electrical or electronic components, wherein the technical effects may be achieved by performing at least one of the following action or operations: i) communicating with one or more user devices to cause the one or more user devices to present the extended reality collaboration environment including a personalized avatar of a first user associated with a first user device of the one or more user devices, wherein the extended reality collaboration environment corresponds to a real-time representation of a physical space, ii) receiving sensor data from a sensor including data representing the physical space, the sensor data comprising sensor data from at least one of: a camera, a microphone, a motion sensor, an environmental sensor, and other sensor devices configured to capture real-time and/or historical aspects of the physical space, iii) generating the extended reality collaboration environment corresponding to the physical space based at least upon the received sensor data, wherein the extended reality collaboration environment comprises a virtual representation of the physical space with the personalized avatar of the first user, iv) receiving user sensor data from the first user device, the user sensor data corresponding to user inputs from the first user device, v) enabling interaction between the first user and the physical space within the extended reality collaboration environment on the user inputs from the first user device, and/or vi) presenting the interaction between the first user and the physical space within the extended reality collaboration environment on the one or more additional user devices.

### Exemplary Employee Extended Reality Computing System

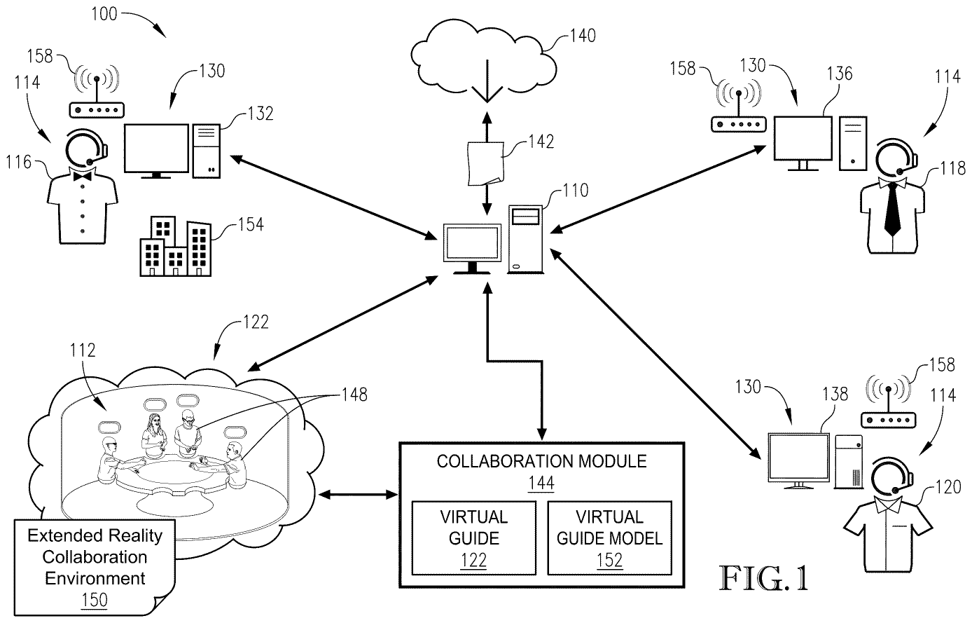

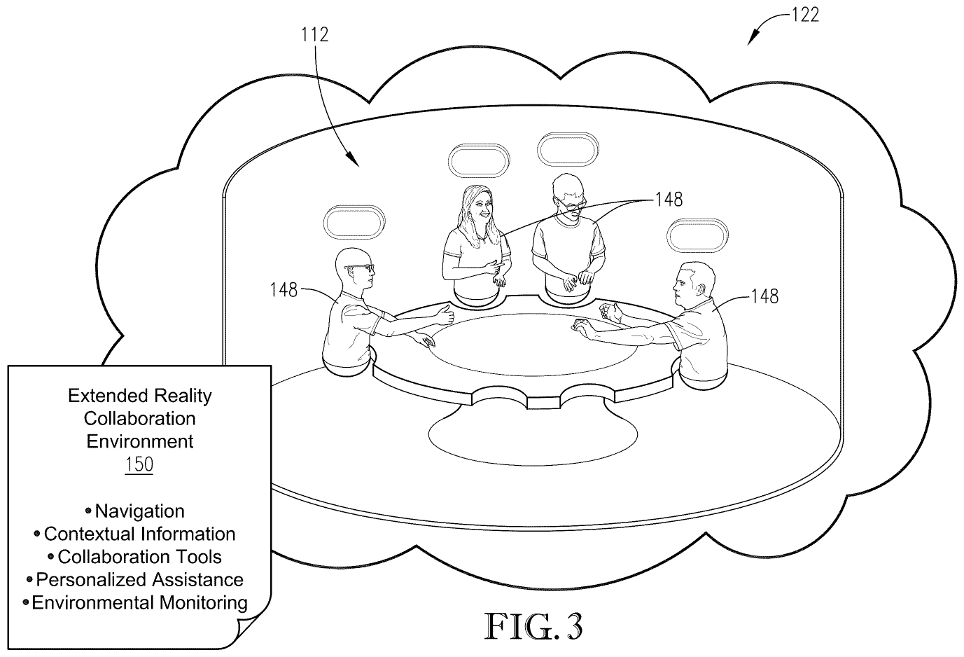

FIG. 1 depicts a simplified schematic diagram of a collaboration system 100 including an extended reality collaboration environment computing system 110 for supporting extended reality (XR) collaboration environments 112, shown and described in greater detail in FIG. 3, enabling interactions between one or more users 114 within the extended reality collaboration environment 112. For example, the extended reality collaboration environment 112 enables a physical space user 116 (e.g., an in-person employee) to interact with a virtual user 118 (e.g., a remote employee) and/or an additional user 120 (e.g., an additional in-person employee or an additional remote employee) in the extended reality collaboration environment 112 using one or more virtual guides 122. The extended reality collaboration environment 112 may include some virtual users 118, all virtual users 118, and/or some physical space users 116 in combination therewith.

The extended reality collaboration environment computing system 110 may be communicatively coupled to one or more additional user computing devices 130 associated with the one or more users 114, e.g., an employee computing device 132 associated with the physical space user 116, a virtual user computing device 136 associated with the virtual user 118, and a user computing device 138 associated with the additional user 120. The extended reality collaboration environment computing system 110 may be communicatively coupled to a database 140, e.g., a cloud-based storage device, which may store historical interactions 142, such as recorded historical virtual guides 122, any historical interaction between a historical physical space user 116 and historical virtual user 118, and/or any other historical interactions. The collaboration system 100 further includes a collaboration module 144 for generating one or more virtual guides 122, e.g., including one or more collaborative extended reality environments 112, one or more avatars 148 representing one or more users 114, and/or one or more extended reality collaboration environments 150, described below, which may be presented, e.g., within the collaborative extended reality environment 112, to the physical space user 116 and/or the virtual user 118 using a virtual guide 122.

In certain embodiments described herein, the collaboration system 100 may support a plurality of different virtual guides 122 associated with a plurality of different collaborative extended reality environments 112 and/or a plurality of different users 114, e.g., avatars 148 of different additional users 120. For example, and without limitation, the collaboration system 100 may generate the extended reality collaboration environment 112 including an office space, representative of an actual or simulated office, a conference space, and/or a workspace associated with the virtual user 118 and/or the physical space user 116. The extended reality collaboration environment 112 may include a representation of an actual, or simulated, residential property, e.g., an interior of a home, a neighborhood including one or more residential properties and surrounding structures or objects, e.g., trees, houses, roads, etc. In the illustrated embodiment, the extended reality collaboration environment 112 may be embodied as an interior room of a residential home associated with the user 114.

The collaboration module 144 includes a virtual guide model 152, e.g., a machine learning or artificial intelligence-based model that may be trained using historical interactions 142. One or more inputs may be applied to the virtual guide model 152 and the virtual guide model 152 may generate one or more outputs. For example, the virtual guide model 152 may be used to generate one or more outputs including virtual guides 122, e.g., generating the virtual guide model 152 and/or one or more avatars 148, enabling the user 114 to interact with the avatars 148 within the extended reality collaboration environment 112. The virtual guide model 152 may also be used to generate the one or more extended reality collaboration environments 150. In certain embodiments, the collaboration module 144 may store and/or retrieve from the database 140, one or more pre-generated virtual guides 122, e.g., suitable for various users 114. In some embodiments, the collaboration module 144, and/or the user 114, may select a virtual guide 122 from pre-generated virtual guides 122 to be completed by the collaboration module 144.

In some embodiments, the virtual guide model 152 may generate one or more user specific or customized virtual guides 122 that may be tailored to the prior behavior or performance of the user 114. Additionally, or alternatively, the virtual guide model 152 may be re-trained using historical interactions 142 associated with the user 114, e.g., during prior participation of the physical space user 116 in historical virtual guides 122. Additionally, or alternatively, the historical interactions 142 associated with the user 114 may be applied as an input to the trained virtual guide model 152. In certain embodiments, the virtual user 118 may provide physical space user 116 specific feedback regarding the performance of the user 114 during an interaction and the feedback may be used to re-train the instruction model using the feedback and/or the feedback may be applied as an input to the instruction model. For example, during an interaction the user 114 may have difficultly relaying information regarding a topic, and as such, based on the model's 152 evaluation of the additional user 120 performance using the virtual guide 122, the collaboration module 144, e.g., using the virtual guide model 152, may generate a new, user specific virtual guide 122 associated with the topic.

In some embodiments, the collaboration module 144 may generate a plurality of pre-generated virtual guides 122 having various levels of sophistication. For example, each of the pre-generated virtual guides 122 may be scored based on sophistication. A lower score may be associated with reduced sophistication. For example, a lower score pre-generated virtual guide 122 may be associated with routine interactions with the extended reality collaboration environment 112 and the virtual guide model 152. A higher score pre-generated virtual guide 122 may be associated with a complex interaction and the virtual guide model 152 including additional processing and messages to assist the user 114. The collaboration module 144 and/or the user 114 may select pre-generated messages based on prior interactions of the user 114. Additionally, or alternatively, the pre-generated virtual guides 122 may be generated based on a prior historical interaction, e.g., a historical interaction and/or a historical interaction with an additional user 120. In certain embodiments, the virtual guide model 152 may generate a virtual guide 122 that may be based on a plurality of historical interactions and/or historical additional users 120. In some embodiments, the collaboration module 144, and/or the virtual guide model 152, may generate pre-generated virtual guides 122 based on selected criteria, e.g., selected by the virtual user 118 or the physical space user 116. Selected criteria may include, for example and without limitation, various types of interactions (e.g., meetings, presentations, social events) and types and/or numbers of additional users 120 (e.g., additional users demographics, such as age, occupation, residential location, native language, etc.).

Each of the virtual users 118, the physical space users 116, and any additional users 120 may be represented within the extended reality collaboration environment 112 as an avatar 148. The avatar 148 represents an actual user 114, either while the user 114 may be actively interacting with the system 100, e.g., in real-time while one or more sensors of user computing devices 130 or sensors of the physical space 154 may be collecting data associated with the user 114, or alternatively, while the user 114 may not be actively interacting with the system 100, e.g., the avatar 148 has been trained to represent the users 114 based on the historical interactions, statements or phrases, and/or mannerisms of the user 114. For example, the physical space user 116 may interact with the system 100 using virtual guides 122 while the virtual user 118 may not be necessarily interacting with the system 100, e.g., conserving employee resources. Additionally or alternatively, during an initial interaction, the physical space user 116 may interact with an avatar 148 representing a virtual user 118 who may be not currently interacting with the system, and then during a subsequent portion of the interaction, the physical space user 116 may interact with an avatar 148 representing a virtual user 118 who may be currently interacting with the system 100, enabling the virtual user 118 to interact in real-time.

In some alternative embodiments, the avatar 148 may not necessarily represent a singular actual user 114, rather, the avatar 148 may be trained to represent a plurality of different users 114. For example, the additional user's avatar 148 may be an artificially generated additional user 120 (referred to herein as an AI generated avatar 148), e.g., the avatar 148 does not represent of an actual additional user 120, but rather a plurality of different additional users 120. The artificially generated additional users' avatar 148 may be particularly useful for user 114 during an initial interaction with the extended reality collaborative environment 112, e.g., before the user 114 may be ready to interact an additional user 120. Subsequently, during an advanced interaction, the avatar 148 may represent an actual additional user 120 currently interacting with the system 100 during a current interaction, e.g., in real-time while one or more sensors of the user computing device 138 and/or the sensors of the physical space 154 may be collecting data associated with the additional user 120. Additionally, or alternatively, the system 100 may generate various versions of the avatar 148 representing various simulated additional users 120 to improve or facilitate the virtual guides 122.

The different types of additional users' avatars 148 enable the collaboration system 100 to provide various virtual guides 122 with various types of users 114 for instructing a user 114 to navigate the collaborative extended reality environment 112. For example, during early phases of interaction, e.g., when a user 114 may be inexperienced working in a collaborative extended reality environment 112, the collaboration system 100 may deploy virtual guides 122 to assist the user 114 through interactions with the collaborative extended reality environment 112 to build the confidence of the user 114. Subsequently, the physical space user 116 may graduate to virtual guides 122 that assist the user to facilitate their interactions with the collaboration system 100.

The physical space user 116 computing device 124 may display the extended reality collaboration environment 112 and the avatars 148, e.g., the avatar 148 of the additional user 120, the avatar 148 of the virtual user 118, and/or the avatar 148 of the physical space user 116, within the extended reality collaboration environment 112. Each of the user computing devices 130 may display the extended reality collaboration environment 112 and/or one or more of the avatars 148. In the illustrated embodiment, the system 100 may cause the physical space user computing device 132 and/or the virtual user computing device 136 to display one or more extended reality collaboration environments 150. In some embodiments, the extended reality collaboration environment 150 may be not displayed on the user computing device 138.

In certain embodiments described herein, the extended reality collaboration environment 150 may be generated by the virtual user 118 and/or a virtual guide model 152 trained using historical interactions 142. The extended reality collaboration environment 150 may include communication, e.g., text and/or audio, for directing and/or providing assistance to the user 114. The communication may prompt the user 114 to interact with one or more collaborative elements within the collaborative extended reality environment 112. The extended reality collaboration environment 150 may prompt the physical space user 116 to navigate through the collaborative extended reality environment 112. The extended reality collaboration environment 150 may present information, e.g., documents, presentations, etc., that the user 114 may relay to the additional user 120.

Additionally, or alternatively, the extended reality collaboration environment 150 includes statements or phrases that the user 114 should relay to the additional user 120, e.g., the user 114 may read the statements substantially verbatim, to the additional user 120. The extended reality collaboration environment 150 includes a description of the collaborative extended reality environment 112, e.g., an indication that one or more collaborative elements can be interacted with. The extended reality collaboration environment 150 may be generated by the model 152, then transmitted to the virtual user computing device 136 where the extended reality collaboration environment 150 may be modified, before the communication may be subsequently transferred user computing device 130 for being displayed to the user 114.

In certain embodiments described herein, the collaboration module 144 may include a plurality of different virtual guide models 152 each trained using different training dataset. For example, the virtual guide model 152 may be trained to generate the virtual guides 122 for each extended reality collaboration environment 112 and each of the one or more user 114, e.g., physical space users 116 and virtual users 118. The collaboration module 144 may also include an avatar model that may be trained to generate the avatar, e.g., a physical space user 116 or a virtual user 118, based on historical interactions between users 114. The collaboration module 144 may include a collaboration model that may be trained to generate the extended reality collaboration environment 150, in real-time, during a current interaction and/or in addition to the current virtual guide 122. The virtual guide model 152 may be a single or individual model, and inputs may be applied, e.g., in one instance, to generate a plurality of outputs including one or more virtual guides 122, one or more avatars 148, and/or one or more interaction recommendations.

In certain embodiments, a current interaction may be applied to the virtual guide model 152, to generate the one or more interaction recommendations that may be presented to the user 114 in real time during the current interaction. Generating the extended reality collaboration environment 150 may be triggered by a question, a statement or request, and/or the user 114, generally referred to herein as a collaboration interaction. Triggering generation of the supplemental interaction recommendations may be triggered by the user 114, e.g., the physical space user 116 or the virtual user 118, for example, by transmitting one or more messages with the collaboration system 100. As such, the collaboration system 100 provides support for a user 114 during an interaction in the collaborative extended reality environment 112 to guide the physical space user 116 through interactions with an additional user 120.

### Exemplary Computing Network

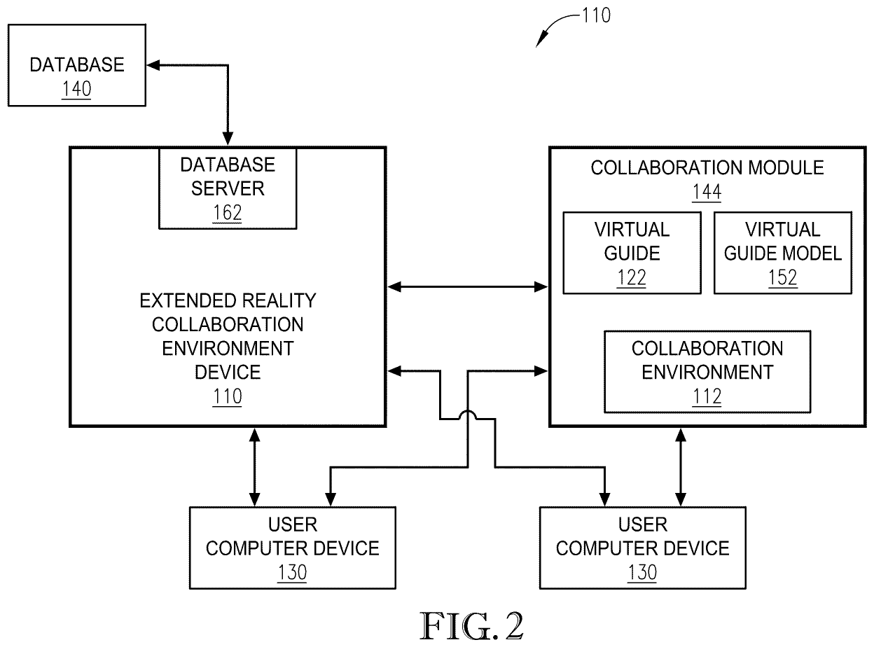

FIG. 2 depicts a simplified block diagram of the exemplary extended reality collaboration environment computing system 110 for use with the collaboration system 100, shown in FIG. 1. The extended reality collaboration environment computing system 110 may provide the extended reality collaboration environment 112 enabling the user 114 to interact with a physical space user 116 and/or a virtual user 118.

In the exemplary embodiment, user computing devices 130 are computing devices that include a web browser or a software application, which enables user computing devices 130 to communicate with the extended reality collaboration environment computing system 110 using the Internet. More specifically, user computing devices 130 are communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. User computing devices 130 may include the user computing device 130 and/or interface of user computing device, described herein.

User computing devices 130 may be any device capable of accessing the Internet including, but not limited to, a mobile device, a desktop computing, a laptop computing, a personal digital assistant (PDA), a cellular phone, a smartphone, a tablet, a phablet, wearable electronics, smart watch, virtual headsets or glasses (e.g., AR (augmented reality), VR (virtual reality), or XR (extended reality) headsets or glasses), smart glasses, a kiosk, chat bots, or other web-based connectable equipment or mobile devices. In alternative embodiments, user computing devices 130 are capable of accessing Collaborative extended reality environments 112, such as through collaboration modules 144.

A database server 162 may be communicatively coupled to a database 140 that stores data. In one embodiment, database 140 may include scan files, replicant personas, digital twins, collaborative extended reality environments 112, business information, user 114 information, and/or user 114 preferences. In the exemplary embodiment, database 140 may be stored remotely from extended reality collaboration environment computing system 110 and/or collaboration module 144. Additionally, or alternatively, database 140 may be decentralized. In the exemplary embodiment, a user 114 may access database 140 via user computing devices 130 by logging onto the system 100, e.g., by transmitting communication message to the extended reality collaboration environment computing system 110 and/or collaboration module 144, as described herein.

Extended reality collaboration environment computing system 110 may be communicatively coupled with one or more the user computing devices 130. In some embodiments, extended reality collaboration environment computing system 110 may be associated with or may be part of a computing network associated with business, or in communication with the business' computing network (not shown). In other embodiments, extended reality collaboration environment computing system 110 may be associated with a third party and may be merely in communication with the business' computing network. In some of these embodiments, extended reality collaboration environment computing system 110 may be associated with the collaboration module 144.

One or more collaboration modules 144 may be communicatively coupled with extended reality collaboration environment computing system 110. The one or more collaboration modules 144 each may be associated with an extended reality collaboration environment 112. Collaboration modules 144 may provide tools and/or applications for users 114 to access and interact with their associated collaborative extended reality environments 112 over the Internet. For the purposes of this discussion, collaborative extended reality environment 112 provide immersive environments that simulates how a user 114 receives stimuli in the real world. For example, the collaborative extended reality environment 112 connects physical space users 116 with virtual users 118 such that they can mutually interact using the collaborative extended reality environment.

In one example, virtual reality (VR) goggles allow a user 114 to see a virtual world. The VR goggles determines when the user 114 turns their head and then renders imaging of what may be where the user 114 may be looking. Furthermore, the user 114 may use input tools, such as controllers to interact with the environment displayed by the goggles. A user 114 may then interact with digital objects or avatars 148 that have been added to the extended reality collaboration environment 112.

In some embodiments, collaborative extended reality environments 112 may simulate parts or portions of the real-world and allow users 114 to own and alter locations in the collaborative extended reality environments 112. For example, a user 114 may own a plot of virtual land and build a version of their real-world house on that plot of land. Or a business could build an office or shop to allow users 114 to interact with the replicant persona avatars 148 in that office or shop. In other embodiments, the collaborative extended reality environment simulates a real-world location such as a conference room or office building associated with a user 114. Additionally, the collaborative extended reality environment 112 may include a collaborative element. The collaborative element may include tools such as documents, whiteboards, display device, or presentation that the user 114 can interact with. The collaborative elements may also interface with real-world systems. For example, the user 114 may connect to a physical display in a conference room, control lighting within a space, or manage other equipment within the physical space, facilitating interaction between the virtual environment and the physical space that correspond to the collaborative extended reality environment 112.

In the exemplary embodiment, extended reality collaboration environment computing system 110 and/or collaboration module 144 may communicate with a user computing device (e.g., user computing device 130) to cause the user computing device 130 to present extended reality collaboration environment 112. Extended reality collaboration environment computing system 110 and/or collaboration module 144 may provide video data, audio data, or other data (e.g., haptic feedback data) that may be presented to the user 114 by the user computing device 130. Extended reality collaboration environment computing system 110 and/or collaboration module 144 may receive user input data such as live audio data, live video data, or live motion data from the user computing device 130, and based upon this received user input data, extended reality collaboration environment computing system 110 and/or collaboration module 144 may continually update the extended reality collaboration environment 112.

Additionally, the extended reality collaboration environment computing system 110 may receive sensor data from sensors associated with the physical space 154 corresponding to a user input. For example, the system may respond to motion, voice commands or other speech, and/or other input (e.g., facial expressions) of the user 114 captured by the user computing device 130 or the sensors associated with the physical space 154. Additionally, or alternatively, if extended reality collaboration environment computing system 110 and/or collaboration module 144 determines that the user 114 may be visiting a location associated with an extended reality collaboration environment 112 based upon the input data, an additional user 120 or other individual associated with the location may receive a notification.

In the exemplary embodiment, extended reality collaboration environment computing system 110 may generate an interaction recommendation to a user 114 based upon received user input data. User input that indicates an interaction may include questions input by the user 114 (e.g., as voice or text) or other actions by the user 114. For example, if the user 114 indicates they will be referencing a specific document, extended reality collaboration environment computing system 110 may determine that information or some other assistance should be offered to the user 114 to help them display the document in the extended reality collaboration environment. Additionally, the interaction may include how to modify collaborative elements within the physical space (e.g., turning on or off lights, checking a public address system, coordinating displays in the physical space). The proposed interaction may include information to provide the user 114 (e.g., specific instructions for the user 114 and/or documents to provide to the user 114) and motions or gestures to perform the user 114 or other actions.

In some embodiments, these responses may include actions outside of the extended reality collaboration environment 112, such as sending emails, phone messages, and/or text messages to the user 114. For example, if the user 114 agrees to a commitment within the extended reality collaboration environment 112, extended reality collaboration environment computing system 110 may transmit documents for the user 114 corresponding to the commitment. Transmission of these documents may be triggered by analogous actions in the extended reality collaboration environment 112, such as by dropping a document into a virtual mailbox. In other embodiments, these commitments may include real-time binding offers or quotes (e.g., insurance quotes), to which the user 114 may accept within the extended reality collaboration environment 112. These may be generated based upon data provided by the user 114 within the extended reality collaboration environment 112 and/or other retrieved data about the user 114 (e.g., from a user profile and/or other web sources or databases such as database 140 accessible by extended reality collaboration environment computing system 110). Any input from the user 114 or any additional users 120 may be recorded by extended reality computing system to enable such interactions to be processed and referred back to in the future.

In the exemplary embodiment, when extended reality computing system 110 generates a proposed response, extended reality computing system 110 may determine whether a virtual user 118 may be present at an interface of user computing device (e.g., user computing device 130). For example, extended reality computing system may determine whether the user 114 may be logged in and/or has made any input through the user interface (e.g., speech, motion, keystrokes, etc.) within a threshold period of time.

When the physical space user 116 or virtual user 118 may be present at an interface, extended reality computing system may cause the interface of user computing device 130 to display an interaction recommendation. For example, the interaction recommendation may be displayed as an overlay within the extended reality collaboration environment 112 visible to the virtual user 118 or physical space user 116, although in certain embodiments, the interaction message may not be visible to some of the additional users 114 depending on the configuration of the extended reality collaboration environment 112.

In these cases, the interaction recommendations may direct the user 114 on how to interact with the physical space 154, additional users 120 in the extended reality collaboration environment, and/or other actions within the extended reality collaboration environment 112. For example, if extended reality computing system determines that the additional user 120 may be becoming confused during an interaction with the user 114, the generated interaction recommendations may direct the virtual user 118 to slow down and/or offer additional explanation. These interaction recommendations, for the virtual user 118, may be generated using one or more chatbots and/or using AI programs such as ChatGPT. Additionally, or alternatively, if the physical space user 116 and virtual user 118 or additional user 120 speak different languages, extended reality computing system 110 may provide translation in real time.

In the exemplary embodiment, when the virtual user 118 may be not present at the interface of user computing device 130, extended reality computing system 110 may cause that at least one avatar 148 to perform the proposed response based upon a replicant persona associated with the virtual user 118. In such cases, the avatar 148 may replicate the traits of the virtual user 118 including, but not limited to, the mannerisms, appearance, personality, historical and conversational talking points. Actions or responses of the replicant persona may be generated using one or more chatbots and/or using AI programs such as ChatGPT. Accordingly, the avatar 148 may act as a user interface for the business when the virtual user 118 may be not present or unavailable, with the avatar 148 interacting with users 114 to provide information about and to collect information for the business.

For instance, a replicant persona for a virtual user 118 or other representative for a business may be created and stored. When a user 114 in the extended reality collaboration environment enters the business, the user 114 may be greeted by an avatar 148 of the virtual user 118 that can answer questions and potentially handle the user's request(s). In some examples, a new avatar 148 (e.g., each representing the virtual user 118) may be generated to interact with each user 114. These may be multiple avatars 148 each connected to different personas or multiple avatars 148 with the same persona. Therefore, multiple users 114 could be interacting with their own version of the avatar 148 of the virtual user 118, simultaneously. This allows the business to provide a personal, singular engagement and user specific or customized virtual users 118 that are best able to interact with the additional users 120.

In a further example, an avatar 148 generated to interact with users 114 may be trained to interact with the user 114 within the metaverse in accordance with certain traits of the user 114 learned through virtual or actual interaction with the user 114. In one example, the traits of the user 114 may include the user's 114 body language, the user's 114 speaking accent and/or dialect observed from an initial interaction (real or virtual) with the user 114 for a specific training period (e.g., initial 5 minutes or 10 minutes). Additionally, or alternatively, the traits of the user 114 may be retrieved from a database in which the user's 114 profile and the traits of the user 114 are stored.

In some embodiments, the avatar 148 may be interacting with the user 114 to sell a new product or service (e.g., insurance products) for the user's 114 newly purchased home or vehicle. The avatar 148 may also interact with the user 114 for a claim submitted by the user 114 for an interaction, such as hail or other weather-related incident, flood, fire, or damage to the user's 114 home or other assets, vehicle accidents, and so on. Further, the avatar 148 may interact with the user 114 to facilitate an interaction between a physical space user 116 and a virtual user 118 using the extended reality collaboration environment. Accordingly, the avatar 148 may be trained to show empathy, excitement, joy, kindness, or some other emotion that may be appropriate with the cause of the interaction with the user 114. Additionally, or alternatively, expressing certain traits or mannerisms of the avatar 148 representing the user 114, may help to increase the user's 114 confidence and ability to interact with the additional users 120 within the extended reality collaboration environment 112. The traits may be used to train the avatar 148 to incorporate those traits and/or mannerisms into the avatar 148 within the extended reality collaboration environment 112. In some cases, those traits or mannerisms incorporated into the virtual user's 118 avatar 148 may include similar traits and mannerism expressed by the user 114 or the user's avatar 148.

In some embodiments, the avatar 148 may initially be controlled by a live user 114, for example, to respond to or greet the additional user 120, and/or to interact with the additional user 120 to provide answers or information to the user 114. However, based upon the monitoring of the interaction between the avatar 148 being controlled by the user 114 and the additional user 120, if it may be determined that the interaction may be not meeting a specific criterion, for example, the real virtual user's 118 interactions with the user 114 are not generating the desired responses or feedback from the user 114, the avatar 148 may be controlled by an artificial intelligence (AI) model or a machine-learning model to meet the specific criterion. For example, the user 114 may be having a bad day, and, therefore, may be unable to show an appropriate level of empathy to the additional user 120 while interacting with the additional user 120. Upon detecting such a condition or feedback from the user 114, extended reality computing system 110 may control the avatar 148 via the AI model or the ML model to adjust the level of empathy being presented to the user 114. Conversely, if may be determined that a computing-controlled avatar 148 may be a specific criterion, extended reality computing system 110 may alert a live virtual user 118 to take control of the avatar.

In some examples, based upon a user profile of the user 114 or historical interactions with the user 114, when it may be determined that the virtual user 118 has a specific accent or dialect associated with a specific geographic location, the avatar 148 may interact with the user 114 using the specific accent or dialect. If it may be learned that the virtual user 118 frequently uses jokes, or one-liners while interacting, the avatar 148 may be trained to use similar behavior while interacting with the additional user 120, which may be likely to increase a comfort level of the additional user 120 while interacting with the user's avatar 148.

In addition, using a microphone and/or a camera, the user's 114 facial gestures, hand gestures, body language, and so on, may be recorded (e.g., while the virtual user 118 may be controlling the avatar 148 live) and used for training the avatar 148 to interact with the additional users 120 in a specific way. An artificial intelligence (AI) model or a machine-learning (ML) model may be used to train the avatar 148 to identify which traits of the user 114 are beneficial to mimic or reproduce to increase the additional user's 120 trust and confidence, and/or which traits of the user 114 may not be used by the avatar. The AI or ML model may also be used to train the avatar 148 to use empathy corresponding to the cause of interaction with the avatar. For example, if the additional user 120 has bought a new home or vehicle and may be interacting with the avatar 148 to purchase a new insurance policy, the avatar 148 may use a happy or celebration tone while interacting with the additional user 120. Similarly, if the additional user 120 may be interacting with the avatar 148 to report a damage or injury claim, the avatar 148 may use a more supportive tone while interacting with the additional user 120.

The replicant persona, based upon which the avatar 148 may be controlled, may be generated using one or more of Deep/Machine Learning (ML), Natural Language Processing (NLP), Voice Intelligence, and Artificial Intelligence (AI) to digitally replicate physical features and personality traits, mannerisms, voices, conversational style, quirks, interactions, facial expressions, hand gestures and/or other visible or audible mannerisms, and historical data and roles of the user 114. The replicant persona may be then used to generate one or more avatars 148 to create unique and personalized experiences for the users 114 in a virtual reality or augmented reality space, e.g., extended reality collaboration environment 112.

Data used to develop this replicant persona may include, but may be not limited to, all available interactions from movies, videos, social media posts, interviews, recordings, images, scripts, other sources where a user's 114 (e.g., an virtual user's 118 or a physical space user's 116) true personality and style could ultimately be captured, and/or current or historical interactions with the additional user 120. These data points could then be synthesized by deep/machine learning and cognitive computing and AI Voice subfields to accurately represent the user 114 and how they might respond given certain inputs and scenarios while interacting with the additional user 120.

The replicant persona can be used to generate individual avatars 148 for different interactions. In some further embodiments, the individual avatar 148 may be loaded with or have access to information about the individual user 114 that the avatar 148 may be interacting with. For example, the avatar 148 may know the user's name and call them by name directly. In a business interaction, the avatar 148 may know additional information about the user 114, up to and including account details and/or other private or personally identifiable information.

In some embodiments, where the user 114 (e.g., virtual user 118) to be represented by the avatar 148 may be available, extended reality computing system 110 may use a 3-D indexing tool to scan the virtual user 118. The 3-D indexing tool may scan and capture the physical essence of the virtual user 118 including, but not limited to physical attributes, tattoos, hair style, make-up, clothing, and other interesting aspects of the virtual user 118 to use with an avatar 148 that interacts with the user 114.

In some examples, a user 114 may use his/her user avatar 148 to interact with the extended reality collaborative environment 112, including interacting with other user avatars 148 in the environment. While a user avatar 148 represents the individual user 114 on a one-to-one basis, a replicant persona can have multiple avatars 148 executing simultaneously in different areas of the extended reality collaborative environment 112 or different extended reality collaborative environments 112. For example, a first user 114 may be in an extended reality collaborative environment 112 with a first avatar 148 of the replicant persona, while an additional user 120 may be in a separate extended reality collaborative environment 112 with a second avatar 148 of the same replicant persona. The first user 114 and the additional user 120 are able to separately and simultaneously interact with their own avatar 148 of the replicant user 114.

In the exemplary embodiment, extended reality collaboration environment computing system 110 may provide for a secure exchange of documents and/or other data using a virtual file cabinet mechanism. The virtual file cabinet may enable a user 114 to securely store documents and to authorize other users 114 to access the documents. For example, a user 114 may, through input (e.g., within the extended reality collaboration environment 112, a mobile app, and/or web page) designate documents (e.g., insurance policy documents, insurance cards, and/or documents and/or other data relating to insurance claims) to be stored in the virtual file cabinet, or the documents may automatically be stored in association with the virtual file cabinet in response to certain interactions (e.g., purchase or renewal of an insurance policy and/or filing of an insurance claim). The user 114 may also designate additional users 120 (e.g., physical space users 116, virtual users 118, or other individuals involved with the extended reality collaborative environment) to access any of these stored documents, or extended reality collaboration environment computing system 110 may determine which individuals to authorize access to certain documents stored within the virtual file cabinet. These authorized users 114 may than retrieve, view, and/or trigger a download of these documents, for example, by accessing the virtual file cabinet within the extended reality collaboration environment 112. In embodiments in which the virtual file cabinet includes insurance-related documents, such access enables authorized users 114 to quickly access these documents and determine insurance coverage in real time in case of an interaction, such as an insurance-related interaction.

In the exemplary embodiment, the extended reality collaboration environment computing system 110 may be configured to communicate with one or more user computing devices 130 to cause those user computing devices 130 to present the extended reality collaboration environment 112 to include at least one virtual file cabinet for selectively sharing documents between the various users 114. In certain embodiments, the virtual file cabinet may appear similar to an actual file cabinet or any other item (e.g., a safe or a file cabinet) users 114 would likely understand to indicate a secure place to store documents. The virtual file cabinet may correspond to a real file cabinet in the physical space 154 associated with the extended reality collaborative environment. Alternatively, the virtual file cabinet may appear as any other type of item, point, or node within the extended reality collaboration environment 112 labeled as such (e.g., an icon or button).

As described above, each user 114 may have a corresponding user avatar 148, which may interact with the virtual file cabinet within the extended reality collaboration environment 112 analogously to how a user 114 may interact with a file cabinet in real life (e.g., opening or closing and/or depositing or withdrawing documents). As described in further detail below, access to and/or the appearance of the file cabinet to a particular user 114 may be controlled based upon whether the particular user 114 may be authorized to access any documents stored in the virtual file cabinet. Within the extended reality collaboration environment 112, the virtual file cabinet may include and/or be labeled with text or indicators providing information about the virtual file cabinet (e.g., which user 114 may be associated with the file cabinet, a relationship between the viewer and the user 114 may be associated with the file cabinet, and/or whether the viewer has access to any documents in the virtual file cabinet). For example, the file cabinet may include a lock that requires a combination or code to be entered to allow a user 114 to access documents included within the file cabinet. A different code may be tied to the different documents included with in the virtual file cabinet such that when a code may be entered only the documents linked to that code are shown and are accessible by that user 114.

In the exemplary embodiment, the extended reality collaboration environment computing system 110 may be configured to store one or more documents in the memory in association with the virtual file cabinet. For example, the user 114 may designate documents to store in association with the virtual file cabinet or the extended reality collaboration environment computing system 110 may automatically determine and store, or suggest storing, documents in association with the virtual file cabinet. Additionally, or alternatively, the user 114 may input instructions at a mobile device via mobile application instructions to store documents in associated with the at least one virtual file cabinet. The extended reality collaboration environment computing system 110 may then store the one or more documents in association with the at least one virtual file cabinet in response to receiving the instruction. The user 114 may generate user input data (e.g., by making corresponding movements and gestures) with the user computing device 130 that indicates an intention to store the one or more documents in association with the virtual file cabinet (e.g., dragging and placing, or selecting from a menu). The extended reality collaboration environment computing system 110 may then store the one or more documents in association with the virtual file cabinet in response to receiving this user input data. In certain embodiments, the extended reality collaboration environment computing system 110 may automatically identify documents to store. For example, the extended reality collaboration environment computing system 110 may identify any insurance policy document, insurance cards, and/or insurance claim documents that are associated with the user 114 and may automatically store the documents or generate interaction recommendations for the user 114 to store the documents in the virtual file cabinet.

In the exemplary embodiment, the extended reality collaboration environment computing system 110 may be configured to identify one or more authorized users 114 of the plurality of users 114 to enable access to the at least one virtual file cabinet. Additionally, or alternatively, the user 114 associated with the file cabinet may select other users 114 to receive authorization. For example, the user 114 may submit instructions at the mobile device via the mobile application instructions to designate one or more users 114 as authorized to access the one or more documents, and the extended reality collaboration environment computing system 110 may identify one or more authorized users 114 based upon the received instruction. The user 114 may submit similar instructions through another channel, such as through interaction within the extended reality collaboration environment 112 itself and/or through another computing device.

In certain embodiments, the extended reality collaboration environment computing system 110 may automatically determine who should have access to the virtual lock box. For example, the extended reality collaboration environment computing system 110 may identify any virtual users 118 associated with the user 114 and/or any other individuals involved in claims submitted by the user 114 (e.g., other parties of an interaction, other insurers, police officers, repair technicians, etc.) as authorized to access one or more of the documents stored in association with the virtual file cabinet.

In the exemplary embodiment, the extended reality collaboration environment computing system 110 may be configured to provide access to the one or more documents in response to the identified one or more authorized users 114 interacting with the virtual file cabinet in the extended reality collaboration environment 112. For example, the authorized users 114 may open, click, or tap on, or otherwise interact with the virtual file cabinet in the extended reality collaboration environment 112, which may enable the authorized users 114 to view of download the documents. Additionally, or alternatively, the documents may be viewed within the extended reality collaboration environment 112. Additionally, or alternatively, accessing the documents in the extended reality collaboration environment 112 may trigger a download or other transfer of data that enables the documents to be viewed through a different channel, such as through the mobile app, web page, and/or another type of file-viewing application.

In the exemplary embodiment, the extended reality collaboration environment computing system 110 may provide for a real time instruction support in the extended reality collaboration environment 112. The extended reality collaboration environment computing system 110 may receive sensor data from the user computing devices 130 (e.g., data captured by smart glasses, biometric sensors, etc.), which may be used to determine if an interaction (e.g., an incident or other interaction with an additional user 120) has occurred. In response to detecting an interaction and/or receiving input from the user 114 (e.g., as a voice command) that an interaction has occurred, the extended reality collaboration environment computing system 110 may prompt the user 114 to interact with a live virtual user 118 and/or replicant persona in the extended reality collaboration environment 112 as described above.

The extended reality collaboration environment computing system 110 may provide guidance and/or instructions to the user 114 via the user computing device 130, for example, as prompts displayed within the extended reality collaboration environment 112 and/or instructions provided by a virtual user avatar. These prompts may include text or speech (e.g., speech associated with the virtual avatars 148 described above). The prompts may include interaction recommendations for facilitating the user's 114 interaction with the extended reality collaborative environment 112. For example, the prompts may instruct the user 114 how to connect to displays in the physical space 154 or navigate within the extended reality collaborative environment 112.

The user computing device 130 may also passively collect data, such as image and/or audio data, in response to the interaction being detected. Additionally, sensors in the physical space 154 may also collect data in response to the interaction being detected. This collected information may be used to determine if additional resources, such as additional users 120 or other personnel, need to be contacted, and automatically initiate such contact (e.g., by transmitting an invite notification and/or presenting a virtual user avatar 148 within the extended reality collaboration environment 112 as described above). The collected information may further be used to generate digital twins, simulations, and/or visual reconstructions of the interaction, which may be used to analyze the interaction. In some embodiments, these reconstructions may be viewed within the extended reality collaboration environment 112.

In the exemplary embodiment, the extended reality collaboration environment computing system 110 may be configured to receive sensor data from the user computing devices 130. For example, at least some of the user computing device 130 may include cameras, microphones, motion sensors (e.g., accelerometers and/or gyroscopes), location sensors (e.g., GPS), radar, lidar, and/or any other types of sensors. This data may be received (e.g., continuously, or periodically) prior to, during, and following an interaction. As described in further detail below, this sensor data may be used by the extended reality collaboration environment computing system 110 to determine when an interaction has occurred and to gather information about the nature, scene, context, and results of the interaction.

In the exemplary embodiment, the extended reality collaboration environment computing system 110 may be configured to receive sensor data from sensors in the physical space 154. For example, at least some of the sensors in the physical space 154 may include cameras, microphones, motion sensors (e.g., accelerometers and/or gyroscopes), location sensors (e.g., GPS), radar, lidar, and/or any other types of sensors. This data may be received (e.g., continuously, or periodically) prior to, during, and following an interaction. As described in further detail below, this sensor data may be used by the extended reality collaboration environment computing system 110 to determine when an interaction has occurred and to gather information about the nature, scene, context, and results of the interaction.

In the exemplary embodiment, the extended reality collaboration environment computing system 110 may be further configured to determine, based upon the received sensor data, that an interaction has occurred. In certain embodiments, this determination may be made by analyzing audio, video, and/or motion data, for example, using AI and/or machine learning techniques and/or by comparing such data to one or more predefined thresholds indicative that an interaction has occurred.

The determination may be made based upon detected voice, speech, facial expressions, and/or gestures made by the user 114 or other individuals in the area. For example, the extended reality collaboration environment computing system 110 may utilize specific voice commands or phrases made by the user 114 (e.g., saying “in an interaction”) to determine an interaction has occurred and initiate an appropriate response. Additionally, or alternatively, the extended reality collaboration environment computing system 110 may analyze non-structured speech or voice (e.g., using AI and/or chatbots) to determine that the non-structured speech or voice indicates an interaction has occurred. When it may be determined an interaction has occurred, the user 114 may be alerted to launch or access the extended reality collaboration environment 112 via the user computing device 130 using voice commands.

The extended reality collaboration environment computing system 110 may configured to detect one or more voice commands input by the first user 114 to the first user computing device 130. As described above, some of these voice commands may relate to an indication that an interaction has occurred. Additionally, the voice commands may request specific actions, such as contacting a virtual user 118 (e.g., by saying “contact user”). The extended reality collaboration environment computing system 110 may analyze these voice commands (e.g., using AI and/or chatbots and/or by performing a lookup based upon the received speech) to determine an appropriate response. For example, saying “contact user” may bring the user 114, user's staff, or user's machine learning bot/avatar 148 or replicant persona, into the extended reality collaborative environment 112 for discussion or other interaction with the user 114. Additionally or alternatively, the extended reality collaboration environment computing system 110 may present within the extended reality collaboration environment 112 to a user 114 using a user device of the user computing devices 130, a recommendation to interact with the user 114 within the extended reality collaboration environment 112.

As described above, extended reality collaboration environment computing system 110 may generate responses to be performed by avatars 148 and/or recommended to live user 114 and/or other user personnel and may retrieve relevant information for review by the user 114. Additionally, or alternatively, the extended reality collaboration environment computing system 110 may determine to perform these actions (e.g., contacting emergency personnel) even without a specific voice command. For example, if the extended reality collaboration environment computing system 110 determines a sufficiently severe interaction has occurred, the extended reality collaboration environment computing system 110 may automatically contact personnel through an appropriate channel to request assistance and/or provide relevant information (e.g., a location of the interaction and/or identities of persons involved).

In the exemplary embodiment, in response to determining the interaction has occurred, the extended reality collaboration environment computing system 110 may be configured to present within the extended reality collaboration environment 112 one or more interaction recommendations using the user computing device 130. The interaction recommendations may be presented as text, audible commands, and/or statements made by avatars 148 within the extended reality collaboration environment 112. Examples of such recommendations may include instructions on how to interact with the physical space 154 using the collaborative the extended reality environment 112 and/or documents that may be relevant to the interaction. Additionally, or alternatively, these recommendations may be generated using AI and/or chatbot technology, for example, to gather as much information as possible relevant to the interaction. The extended reality collaboration environment computing system 110 may record interactions or other information resulting from the user 114 following these instruction recommendations. The captured information may be transmitted back to the extended reality collaboration environment computing system 110 to be recorded and/or analyzed further.

In some embodiments, the extended reality collaboration environment computing system 110 may automatically identify other individuals present at the interaction. For example, the extended reality collaboration environment computing system 110 may detect one or devices proximate to the user computing device 130 (e.g., using Bluetooth device identification and/or another appropriate form of wireless communication), and may perform a lookup to identify individuals present during the interaction based upon the detected one or more devices. In certain embodiments, the extended reality collaboration environment computing system 110 may identify individuals based upon detecting and analyzing voices of or statements made by the individuals detected by the user computing device 130.

In the exemplary embodiment, the extended reality collaboration environment computing system 110 may be further configured to generate an interaction profile including the information collected by the user 114 using the first user computing device 130 and the sensors in the physical space 154 during the interaction. The interaction profile may be a database, database component, and/or data structure (e.g., stored in database 140) that stores various types of information associated with the interaction. In addition to the sensor data and information gathered by the user 114 and the sensors within the physical space 154 associated with the interaction, other relevant data may be recorded in association with the interaction profile, such as a date, time, location, weather, and/or other data associated with or providing context to the interaction. In some embodiments, the extended reality collaboration environment computing system 110 may retrieve additional documents, such user 114 files, associated with the interaction and store these documents in association with the interaction profile.

The extended reality collaboration environment computing system 110 may generate one or more digital twins representing people or other objects involved in the interaction and/or a visual representation and/or reconstruction of the interaction based upon information included in the interaction profile. For example, the extended reality collaboration environment computing system 110 may parse the interaction profile for sensor data, speech data, and/or documents relating to the interaction to identify positions and orientations of relevant people and objects during the course of the interaction. In certain embodiments, AI and/or machine learning techniques may be utilized for such parsing. In some embodiments, the extended reality collaboration environment computing system 110 the visual representation may be presented within the extended reality collaboration environment 112, so that virtual users 118, physical space users 116, and/or others reviewing the interaction may do so in a three-dimensional environment.

### Exemplary Interaction

FIG. 3 depicts an example virtual guide 122 for use with the collaboration system 100 shown in FIG. 1. The virtual guide 122 includes the extended reality collaboration environment 112 that may be displayed on the user computing device 130 (e.g., the virtual user computing device 136, the physical space user computing device 132, and/or the user computing device 138) and one or more avatars 148 representing one or more users 114 (e.g., the virtual user 118, the physical space user 116, and/or the additional user 120). In the exemplary embodiment, the virtual guide 122 includes the extended reality collaboration environment 150, presented to the physical space user computing device 132 and/or the virtual user computing device 136, within the extended reality collaboration environment 112. In some alternative embodiments, the extended reality collaboration environment 150 may be presented outside of the extended reality collaboration environment 112. The extended reality collaboration environment 150 may include feedback, e.g., regarding the physical space user's 116 performance during the interaction, warnings, a script for the user 114 to communicate to the additional user 120 during a current interaction, phrases, or words to avoid using, and documents relevant to the current interaction. The interaction recommendation may include any suitable teaching or interaction data, e.g., that the virtual user 118 wishes to communicate to the physical space user 116, e.g., without the knowledge of any additional users 120.

Current interactions, e.g., between the user 114 and the additional user 120 may be continuously or semi continuously applied to a trained interaction recommendation model to generate one or more model outputs including one or more virtual guides 122 for providing feedback, warnings, emotional state data of additional users, scripts, phrases, or words to avoid, and/or the additional data. The current interaction may be applied to the interaction recommendation model in real-time such that model outputs may be transmitted to the user computing device 132 such that the user 114 may utilize the virtual guide 122 in real time during the current interaction. For example, responses, statements, body language, facial expressions, biometric parameters of the additional user 120, as sensed by sensors, during a current interaction where the user 114 may be using the virtual guide 122, the virtual guide model 152 may be applied to determine model outputs including feedback that indicates to the user 114 the information about the additional users 120, a script that the user 114 may use to communicate to the additional user 120. The script may be a phrase or in sentence form, such that the user 114 may merely repeat or say the script verbatim to the additional user 120. The script or teleprompt may be determined based on the interaction with the additional users 120, and as such, the script may include language that addresses the current interaction.

The extended reality collaboration environment 112 may be generated and provided via one or more computing devices 130 and/or the extended reality collaboration environment computing system 110 of the collaboration system 100 depicted in FIG. 1, and/or via other suitable computing devices. The extended reality collaboration environment 112 may include additional, fewer, or alternate elements to those depicted in FIG. 3, including any components of a virtual environment described in this detailed description.

The perspective of the extended reality collaboration environment 112 shown in FIG. 3 corresponds to one possible view of a three-dimensional virtual space represented by the extended reality collaboration environment 112 that corresponds to the physical space 154. FIG. 3 shows a “ground view” or “eye level” perspective view, however additional or alternative views may be displayed to a user 114. Alternative views may include, for example and without limitation, a typical view for a user 114 in the extended reality collaboration environment 112 may correspond to a viewing perspective (e.g., position and viewing angle) of a user 114, while the user may be in a standing or seated position. The viewing perspective of the user 114 may vary in accordance with the user's navigation about the extended reality collaboration environment 112. Additionally, or alternatively, a view from the perspective of the user 114 may be considered an “overhead” view, the user 114 may, in certain embodiments, move vertically about the extended reality collaboration environment 112 to access an overhead view of the extended reality collaboration environment 112. Accordingly, numerous views of the extended reality collaboration environment 112 are possible and available for access to the user.

The extended reality collaboration environment 112 may represent any suitable environment, for example and without limitation, an interior of an office space enabling virtual collaboration, e.g., between virtual users 118 and physical space users 116, a street view of homes or buildings enabling virtual inspection of damage (e.g., hail or wind) to the exterior of the home or buildings, and/or an interior of home or building enabling inspection of damage (e.g., flood or fire) to the interior of the home and/or objects within the home. In some embodiments, the collaboration module 144 may generate one or more virtual environments within a single interaction, and alternative between causing the user computing device 130 to display the different virtual environments. For example, a single interaction may include a first virtual environment corresponding to the physical space 154 and second virtual environment displaying an additional residential associated with the interaction.

In some alternative embodiments, the extended reality collaboration environment 112 may include terrain, roads, intersection, bridges, overpasses, rivers, foliage, lakes, and/or rivers etc. The extended reality collaboration environment 112 may include additional or alternative components, including but not limited to signs, traffic lights, vehicles, and/or utility components (e.g., power lines) providing electricity to and/or other components of the extended reality collaboration environment 112.

The extended reality collaboration environment 112 may include a plurality of virtual properties, which may include various commercial properties, residential properties, and/or other properties described herein, including combinations thereof. Any virtual property may be associated with one or more entities (e.g., property owners, renters, lessors, etc.). In certain embodiments, the extended reality collaboration environment 112 may additionally or alternatively include an “undeveloped” property, i.e., a property upon which a structure may be not yet present or fully constructed, but which may still be considered for insurability based upon one or more aspects of the extended reality collaboration environment 112.

Various characteristics of the extended reality collaboration environment 112 may be randomly generated according to the techniques described herein. For example, procedural generation techniques may be applied to determine (1) material composition of structures upon the virtual properties, (2) varying elevation of the terrain of the extended reality collaboration environment 112, (3) rotation, size, and/or placement of various components of the extended reality collaboration environment 112, and/or (4) meteorological elements (e.g., clouds, rain, etc.) of the extended reality collaboration environment 112.

As described herein, the collaboration system 100 may generate personalized virtual content for an interaction. In some embodiments, the collaboration module 144 stores a plurality of virtual guides 122 each associated with an extended reality collaboration environment 112. The user may provide the collaboration system 100 with a criterion of a desired interaction, and the collaboration module 144 and/or the collaboration system 100 may generate personalized content based upon the received criterion. The collaboration system 100 may generate a new extended reality collaboration environment 112 based upon the criterion, the physical space 154 associated with the interaction, and/or historical interactions, by applying the criterion to a trained interaction model. In some alternative embodiments, the collaboration module 144 may select a pre-existing extended reality collaboration environment 112, e.g., stored within the collaboration module 144, based on the received criterion.

Additionally, the collaboration system 100 may determine personalized virtual content in the form of virtual objects such as buildings, cars, rooms, landmarks, geological features, etc. based upon received data collected by user computing devices 130. The collaboration system 100 may then generate one or more of the determined virtual objects based upon the extended reality collaboration environment 112, the personal data, and the determined interaction. The collaboration system 100 then provides, via the user computing device 130, such as a virtual headset, the extended reality collaboration environment 112, one or more virtual objects, avatars 148, and/or the extended reality collaboration environment 150 to the user 114 of the user computing device 130. In some embodiments, the virtual object corresponds to a collaboration element within the physical space 154 associated with the extended reality collaboration environment 112. The user 114 may interact in the extended reality collaboration environment 112 via interface hardware such as a keyboard, joystick, or other physical controller, or the user may provide inputs via a virtual user interface, motion tracking, and/or hand and gesture identification/tracking. Additionally, when the user 114 is located within the physical space 154, the sensors within the space can capture user 114 movement to interact with the collaborative extended reality environment 112.

In certain embodiments, a view of the user 114 in the extended reality collaboration environment 112 may comprise only a portion of the above-described components of the extended reality collaboration environment 112. In particular, due to computing limitations such as limited RAM, a view of the user 114 may be adjusted based upon computing capabilities of the device at which the extended reality collaboration environment 112 may be provided. For example, when certain components of the extended reality collaboration environment 112 are outside of a limited “draw distance” of the user 114, are only in the periphery of the viewing angle of the user 114, or are obstructed by other components of the extended reality collaboration environment 112, the view of the extended reality collaboration environment 112 (1) limit graphical resolution of those certain components, (2) limit the visual detail of those certain components (e.g., by not including smaller “sub-components”), and/or (3) may omit those certain components entirely.

### Exemplary Additional User Device

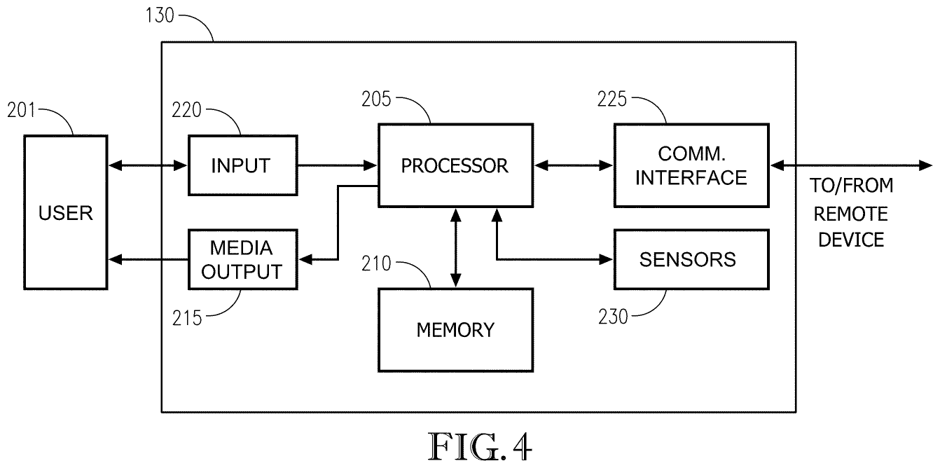

FIG. 4 depicts an exemplary configuration of a user computing device 130 shown in FIG. 1, in accordance with one embodiment of the present disclosure. User computing device 130 may be operated by a user 201. User computing device 130 may include a processor 205 for executing instructions. In certain embodiments, executable instructions are stored in a memory area 210. Processor 205 may include one or more processing units (e.g., in a multi-core configuration). Memory area 210 may be any device allowing information such as executable instructions and/or transaction data to be stored and retrieved. Memory area 210 may include one or more computing readable media.

User computing device 130 may also include at least one media output component 215 for presenting information to user 201. Media output component 215 may be any component capable of conveying information to user 201. In some embodiments, media output component 215 may include an output adapter (not shown) such as a video adapter and/or an audio adapter. An output adapter may be operatively coupled to processor 205 and operatively couplable to an output device such as a display device (e.g., a cathode ray tube (CRT), liquid crystal display (LCD), light emitting diode (LED) display, or “electronic ink” display), an audio output device (e.g., a speaker or headphones), virtual headsets (e.g., AR (Augmented Reality), VR (Virtual Reality), or XR (Extended Reality) headsets).

Media output component 215 may be configured to present a graphical user interface (e.g., a web browser and/or user's application) to user 201. A graphical user interface may include, for example, an online store interface for viewing and/or purchasing items, and/or a wallet application for managing payment information. In certain embodiments, user computing device 130 may include an input device 220 for receiving input from user 401. User 201 may use input device 220 to, without limitation, select and/or enter one or more items to purchase and/or a purchase request, or to access credential information, and/or payment information.

Input device 220 may include, for example, a keyboard, a pointing device, a mouse, a stylus, a touch sensitive panel (e.g., a touch pad or a touch screen), a gyroscope, an accelerometer, a position detector, a biometric input device, an audio input device (e.g., a microphone), and/or a video input device (e.g., a camera). A single component such as a touch screen may function as both an output device of media output component 215 and input device 220.

User computing device 130 may also include a communication interface 225, communicatively coupled to a remote device such as the extended reality collaboration environment computing system 110 (shown in FIG. 1). Communication interface 225 may include, for example, a wired or wireless network adapter and/or a wireless data transceiver for use with a mobile telecommunications network.

Stored in memory area 210 are, for example, computing readable instructions for providing a user interface to user 201 via media output component 215 and, optionally, receiving and processing input from input device 220. A user interface may include, among other possibilities, a web browser and/or a user application. Web browsers enable users, such as user 114, to display and interact with media and other information typically embedded on a web page or a website from the extended reality collaboration environment computing system 110 and/or the collaboration module 144. An additional user's application allows user 201 to interact with, for example, the extended reality collaboration environment computing system 110 and/or the collaboration module 144. For example, instructions may be stored by a cloud service, and the output of the execution of the instructions sent to the media output component 215.

Processor 205 executes computing-executable instructions for implementing aspects of the disclosure. In certain embodiments, the processor 205 may be transformed into a special purpose microprocessor by executing computing-executable instructions or by otherwise being programmed.

### Exemplary Server Device

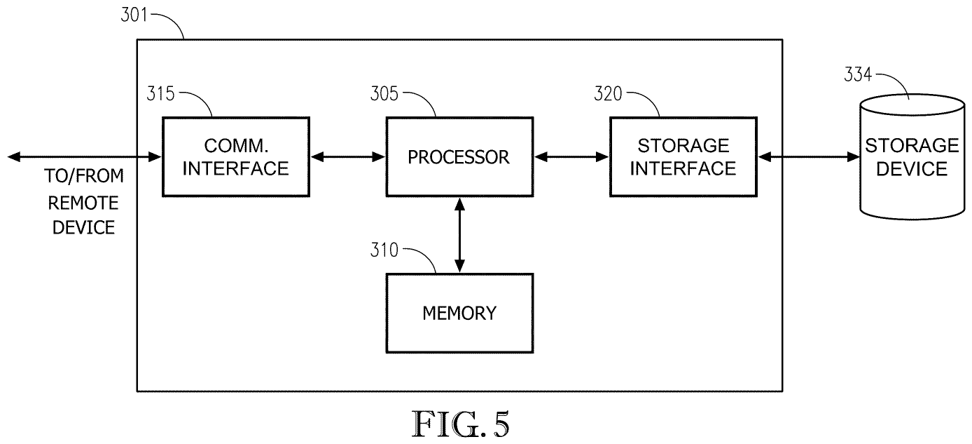

FIG. 5 depicts an exemplary configuration of a server computing device 301, in accordance with one embodiment of the present disclosure. Server computing device 301 may include, but may be not limited to, the extended reality collaboration environment computing system 110 and/or collaboration module 144 (all shown in FIG. 1). Server computing device 301 may also include a processor 305 for executing instructions. Instructions may be stored in a memory area 310. Processor 305 may include one or more processing units (e.g., in a multi-core configuration).

Processor 305 may be operatively coupled to a communication interface 515 such that server computing device 301 may be capable of communicating with a remote device such as another server computing device 301, collaboration module 144, or user computing devices 130 (shown in FIGS. 1 and 2). For example, communication interface 315 may receive requests from user computing devices 130 via the Internet.

Processor 305 may also be operatively coupled to a storage device 134. Storage device 334 may be any computing-operated hardware suitable for storing and/or retrieving data, such as, but not limited to, data associated with database 140 (shown in FIG. 1). In some embodiments, storage device 334 may be integrated in server computing device 301. For example, server computing device 301 may include one or more hard disk drives as storage device 334.

In other embodiments, storage device 334 may be external to server computing device 301 and may be accessed by a plurality of server computing devices 301. For example, storage device 534 may include a storage area network (SAN), a network attached storage (NAS) system, and/or multiple storage units such as hard disks and/or solid state disks in a redundant array of inexpensive disks (RAID) configuration.

In some embodiments, processor 305 may be operatively coupled to storage device 334 via a storage interface 320. Storage interface 320 may be any component capable of providing processor 305 with access to storage device 334. Storage interface 320 may include, for example, an Advanced Technology Attachment (ATA) adapter, a Serial ATA (SATA) adapter, a Small Computing System Interface (SCSI) adapter, a RAID controller, a SAN adapter, a network adapter, and/or any component providing processor 305 with access to storage device 334.

Processor 305 may execute computing-executable instructions for implementing aspects of the disclosure. In some embodiments, the processor 305 may be transformed into a special purpose microprocessor by executing computing-executable instructions or by otherwise being programmed.

### Exemplary Computer-Implemented Method for Interactions in an Extended Reality Collaboration Environment

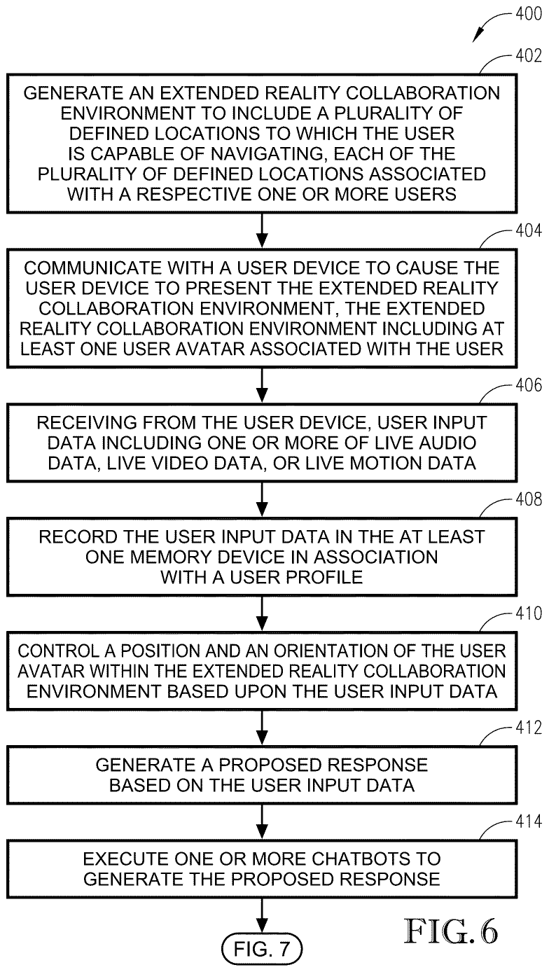

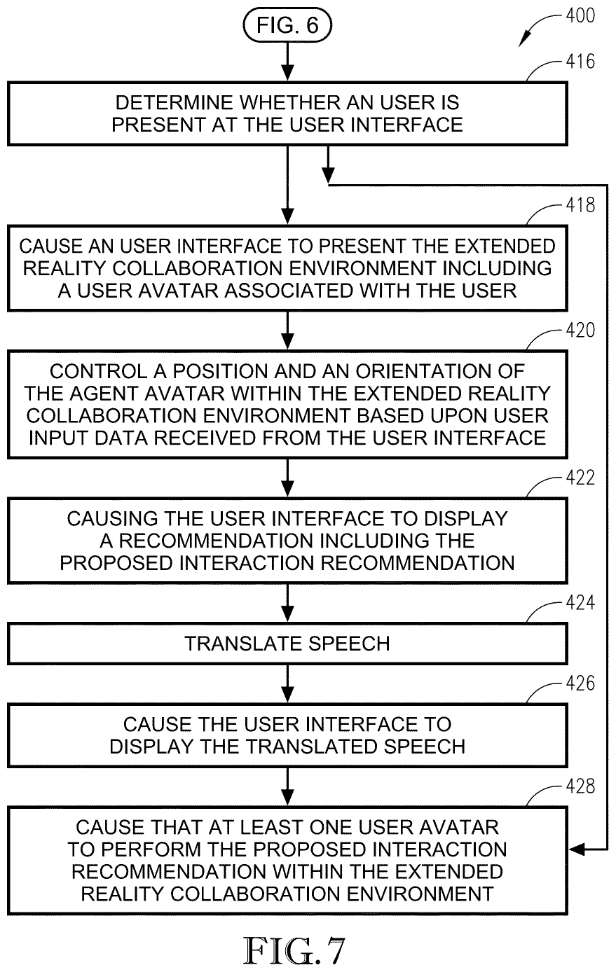

FIGS. 6 and 7 depict a flow chart of an exemplary computer-implemented process 400 for interaction with at least one user in an extended reality collaboration environment 112 using the collaboration system 100 shown in FIG. 1. Process 400 may be implemented by a computing device, for example the extended reality collaboration environment computing system 110 and/or collaboration module 144 (shown in FIG. 1). In the exemplary embodiment, the extended reality collaboration environment computing system 110 may be in communication with one or more collaboration modules 144 and one or more user computing devices 130 (both shown in FIG. 1).

In some embodiments, process 400 may include generating 402 the extended reality collaboration environment 112 to include a plurality of defined locations to which the user may be capable of navigating, each of the plurality of defined locations associated with a respective one or more virtual users 118. The collaborative extended reality environment 112 may also correspond to a physical space 154. In certain embodiments, this action or operation may be performed by the extended reality collaboration environment computing system 110 and/or collaboration module 144 (shown in FIG. 1).

Process 400 may include communicating 404 with the user computing device to cause the user computing device to present the extended reality collaboration environment 112, the extended reality collaboration environment 112 including at least one user avatar 148 associated with the user 114. Additionally, or alternatively, this action or operation may be performed by the extended reality collaboration environment computing system 110 and/or collaboration module 144 (shown in FIG. 1).

In the exemplary embodiment, process 400 may further include receiving 406, from the user computing device, user input data including one or more of live audio data, live video data, or live motion data. Additionally, or alternatively, this action or operation may be performed by the extended reality collaboration environment computing system 110 and/or collaboration module 144 (shown in FIG. 1).

Process 400 may further include recording 408 the user input data in the at least one memory device in association with a user profile. Additionally, or alternatively, this action or operation may be performed by the extended reality collaboration environment computing system 110 and/or collaboration module 144 (shown in FIG. 1).

Process 400 may further include controlling 410 a position and an orientation of the user avatar 148 within the extended reality collaboration environment 112 based upon the user input data. In some embodiments, this action or operation may be performed by the extended reality collaboration environment computing system 110 and/or collaboration module 144 (shown in FIG. 1).

In the exemplary embodiment, process 400 may further include generating 412 a proposed response based upon the user input data. In some embodiments, this action or operation may be performed by the extended reality collaboration environment computing system 110 and/or collaboration module 144 (shown in FIG. 1).

Process 400 may further include executing 414 one or more chatbots to generate the proposed response. In certain embodiments, this action or operation may be performed by the extended reality collaboration environment computing system 110 and/or collaboration module 144 (shown in FIG. 1).

Process 400 may further include determining 416 whether a virtual user 118 may be present at the interface of user computing device. In certain embodiments, this action or operation may be performed by the extended reality collaboration environment computing system 110 and/or collaboration module 144 (shown in FIG. 1).

Process 400 may further include causing 418 the interface of user computing device to present the extended reality collaboration environment 112 including a user avatar 148 associated with the user. In some embodiments, this action or operation may be performed by the extended reality collaboration environment computing system 110 and/or collaboration module 144 (shown in FIG. 1).

In some embodiments, process 400 may further include controlling 420 a position and an orientation of the virtual user avatar 148 within the extended reality collaboration environment 112 based upon virtual user input data received from the interface of user computing device. In certain embodiments, this action or operation may be performed by the extended reality collaboration environment computing system 110 and/or collaboration module 144 (shown in FIG. 1).

Process 400 may further include, when the virtual user 118 is present at the interface of user computing device, causing 422 the interface of user computing device to display an interaction recommendation including the proposed response. In some embodiments, this action or operation may be performed by the extended reality collaboration environment computing system 110 and/or collaboration module 144 (shown in FIG. 1).

In some embodiments, the user input data includes speech, and process 400 further includes, when the user 114 is present at the interface of user computing device, translating 424 the speech. In such embodiments, process 400 may further include causing 426 the interface of user computing device to present the translated speech. In certain embodiments, this action or operation may be performed by the extended reality collaboration environment computing system 110 and/or collaboration module 144 (shown in FIG. 1).

Process 400 may further include, when the user 114 is not present at the interface of user computing device, causing 428 that at least one virtual user avatar 148 to perform the proposed response within the extended reality collaboration environment 112. In some embodiments, this action or operation may be performed by the extended reality collaboration environment computing system 110 and/or collaboration module 144 (shown in FIG. 1).

### Exemplary Computer-Implemented Method for Generating an Avatar

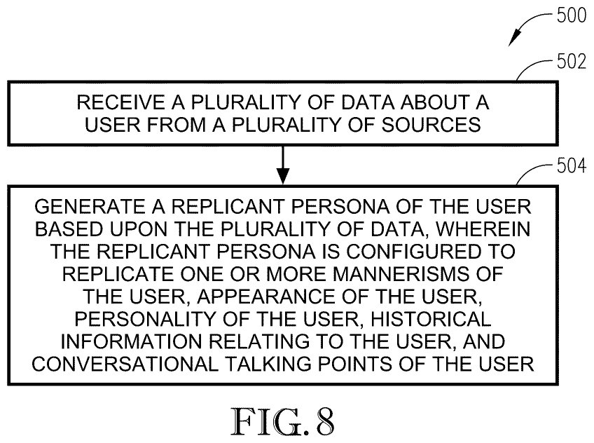

FIG. 8 depicts a flow chart of an exemplary computer-implemented process 500 for generating an avatar 148 for a user 114 or other individual using collaboration system 100 shown in FIG. 1. Process 500 may be implemented by a computing device, for example the extended reality collaboration environment computing system 110 and/or collaboration module 144 (shown in FIG. 1). In the exemplary embodiment, the extended reality collaboration environment computing system 110 may be in communication with one or more collaboration modules 144 and one or more user computing devices 130 (both shown in FIG. 1).

In the exemplary embodiment, process 500 may include receiving 502 a plurality of data about the virtual user 118 from a plurality of sources. In some embodiments, this action or operation may be performed by the extended reality collaboration environment computing system 110 and/or collaboration module 144 (shown in FIG. 1).

Process 500 may include generating 504 a replicant persona of the user 114 based upon the plurality of data, wherein the replicant persona may be configured to replicate one or more of mannerisms of the user 114, appearance of the user 114, personality of the user 114, historical information relating to the user 114, and conversational talking points of the user 114. The proposed response referred to with respect to process 400 (shown in FIGS. 6 and 7) may be generated based at least in part upon the replicant persona. In certain embodiments, the mannerisms of the user 114 may include one or more of: hand gestures of the user 114, facial gestures of the user 114, body language of the user 114, a speaking accent of the user 114, a dialect of the user 114, a personality of the user 114, or emotions of the user 114. In some embodiments, the plurality of data includes social media, behavior data from interviews, recordings, images, and/or historical data about the user 114. In various embodiments, this action or operation may be performed by the extended reality collaboration environment computing system 110 and/or collaboration module 144 (shown in FIG. 1).

In some embodiments, the avatar 148 may be representative of an actual user 114 that may be currently, in real-time, interacting with collaboration system 100. For example, the avatar 148 may be representative of the current and actual behavior of the actual user 114, using sensor data collected in real-time, e.g., by one or more devices in proximity to the user 114. In some other embodiments, the avatar 148 may be representative an actual user 114 that may be not currently interacting with collaboration system 100, rather the avatar 148 may represent potential interactions of the actual user 114, e.g., phrases, mannerisms, previously answered questions, etc. For example, the avatar 148 may be generated while the actual user 114 may be off-line and not interacting with collaboration system 100. In certain embodiments, the avatar 148 may not represent an actual or individual user 114, rather, the avatar 148 may be generated based on a plurality of actual users 114, training material or documents retrieved from the database 140 or additional or alternative sources.

### Exemplary Computer-Implemented Method for Secure Data Exchange in Extended Reality Collaboration Environment

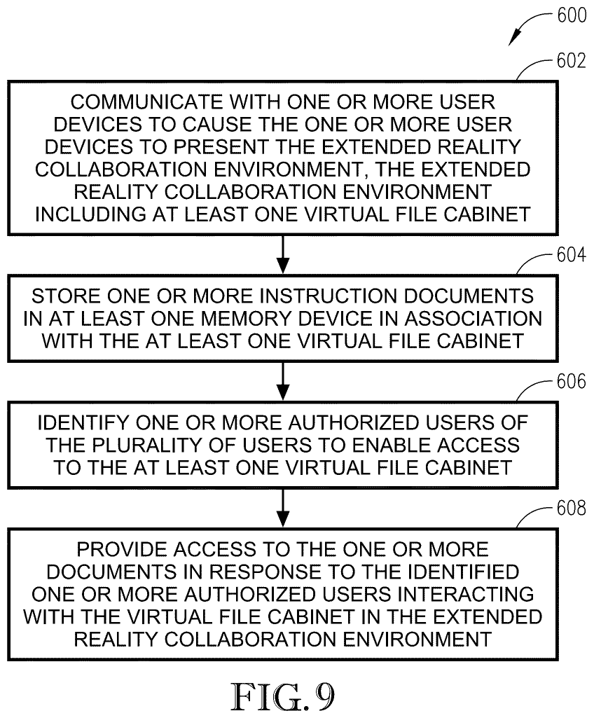

FIG. 9 depicts a flow chart of an exemplary computer-implemented process 600 for providing secure data exchange in a virtual environment such as the extended reality collaboration environment 112 using collaboration system 100 shown in FIG. 1. Process 600 may be implemented by a computing device, for example, the extended reality collaboration environment computing system 110 and/or collaboration module 144 (shown in FIG. 1). In the exemplary embodiment, the extended reality collaboration environment computing system 110 may be in communication with one or more collaboration modules 144 and one or more user computing devices 130 (both shown in FIG. 1).

Process 600 may include communicating 602 with the one or more user computing devices 130 to cause the one or more user computing devices 130 to present the extended reality collaboration environment 112, the extended reality collaboration environment 112 including at least one virtual file cabinet (e.g., associated with a first user 114 of the plurality of users 114). In some embodiments, this action or operation may be performed by the extended reality collaboration environment computing system 110 and/or collaboration module 144 (shown in FIG. 1).

Process 600 may further include storing 604 one or more documents (e.g., the extended reality collaboration environments 150 and/or policy information) in the at least one memory device in association with the at least one virtual file cabinet. In certain embodiments, this action or operation may be performed by the extended reality collaboration environment computing system 110 and/or collaboration module 144 (shown in FIG. 1).

In the exemplary embodiment, process 600 may further include identifying 606 one or more authorized users 114 of the plurality of users 114 to enable access to the at least one virtual file cabinet. In certain embodiments, this action or operation may be performed by the extended reality collaboration environment computing system 110 and/or collaboration module 144 (shown in FIG. 1).

In the exemplary embodiment, process 600 may further include providing access 608 to the one or more documents in response to the identified one or more authorized users 114 interacting with the virtual file cabinet in the extended reality collaboration environment 112. In some embodiments, this action or operation may be performed by the extended reality collaboration environment computing system 110 and/or collaboration module 144 (shown in FIG. 1).

In certain embodiments, process 600 may include exchanging data and/or one or more documents from within the extended reality collaboration environment 112 to an external environment. In some embodiments, data collected within the virtual environment may be securely, e.g., via encryption, transmitted outside of the extended reality collaboration environment 112, e.g., to the user computing devices 130. The collaboration system 100 may be enabled to provide interoperability between an external system and the extended reality collaboration environment 112, while safely and securely enabling data to be transferred. For example, a physical space user's 116 performance during an interaction may be transferred from within the extended reality collaboration environment 112 to the virtual user computing device 136 outside of the extended reality collaboration environment 112, e.g., presenting the data using a program, a visual display, or a graphical user interface not associated with the extended reality collaboration environment 112.

### Exemplary Computer-Implemented Method for Providing Real Time Interaction Recommendations in Extended Reality Collaboration Environment

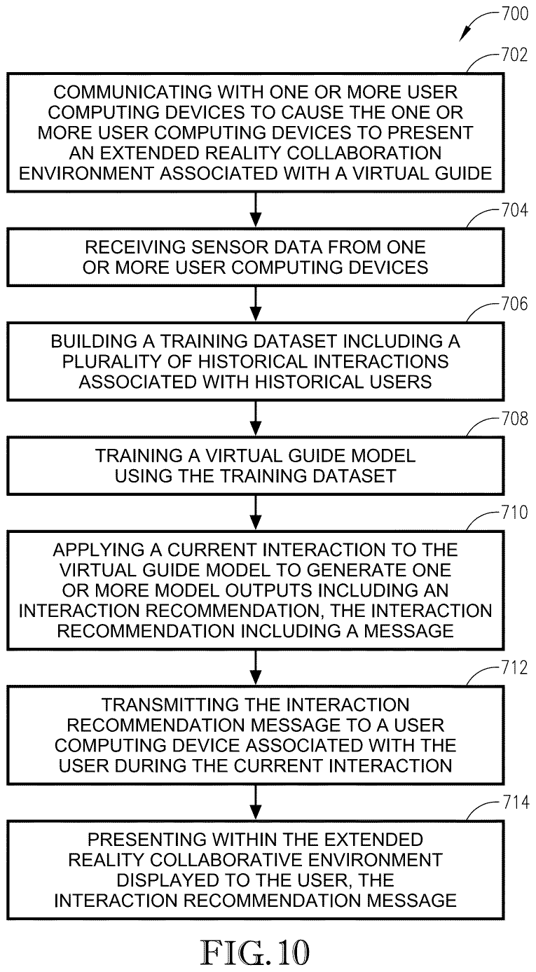

FIG. 10 depicts a flow chart of an exemplary computer-implemented process 700 for providing real time interaction recommendations in an extended reality collaboration environment 112 such as the extended reality collaboration environment 112 using collaboration system 100 shown in FIG. 1. Process 700 may be implemented by a computing device, for example the extended reality collaboration environment computing system 110 and/or collaboration module 144 (shown in FIG. 1). In the exemplary embodiment, the extended reality collaboration environment computing system 110 may be in communication with one or more collaboration modules 144 and one or more user computing devices 130 (both shown in FIG. 1).

In the exemplary embodiment, process 700 may include communicating 702 with one or more user computing devices 130 to cause the one or more user computing devices 130, e.g., the physical space user computing device 132, the virtual user computing device 136, and/or the user computing device 138, to present a extended reality collaboration environment 112 associated with an interaction. In some embodiments, this action or operation may be performed by the extended reality collaboration environment computing system 110 and/or collaboration module 144 (shown in FIG. 1).

Process 700 may further include receiving 704 sensor data from one or more user computing devices 130, e.g., the physical space user computing device 132, the virtual user computing device 136, and/or the user computing device 138. In certain embodiments, this action or operation may be performed by the extended reality collaboration environment computing system 110 and/or collaboration module 144 (shown in FIG. 1). Sensor data may include audio, visual, video stream, or any suitable data to capture interactions between the users 114. In some embodiments, sensor data may include biometric sensors data, e.g., heart rate, stress levels, sweat levels, etc. Sensor data may include location data (e.g., views or live stream images of the physical space 154, temperature and/or pressure of rooms or areas within the physical space 154, sounds of the physical space 154, electronic data associated with objects within the physical space 154, etc.). Locational sensor data may be collected by one or more sensors that are positioned locally relative to the physical space 154, e.g., mounted to a wall or contained within the physical space 154. For example, if a user within the physical space 154 writes on a dry erase board within the physical space 154, the local sensor may capture images of the dry erase board, in real-time, and then the extended reality collaboration environment computing system 110 may present, virtually, the updated images of the dry erase board, such that the virtual user may participate in the extended reality collaboration environment in real-time.

In the exemplary embodiment, process 700 may further include, building 706 a training dataset including a plurality of historical additional user's interactions 142, e.g., historical virtual guides 122, historical interactions between user 114 and trained or seasoned employees, and/or any suitable historical interaction. The historical interaction interactions 142 included in the training dataset may include interactions that were positive, e.g., based on additional users' feedback or upon screening or review of the historical interaction. Similarly, historical interaction interactions 142 that were negative, e.g., based on additional users' feedback or based on a review of the historical interaction, may be excluded from the training dataset.

Process 700 may further include training 708 an interaction recommendation model using the training dataset. Training 708 may include training, or re-training, using updated or new historical interactions or interactions, tuning, adjusting weighting factors, etc., in order to generate the interaction recommendation model. The interaction recommendation model may be trained to generate one or more model outputs when one or more model inputs are applied to the interaction recommendation model. Model inputs may include a current interaction. For example, model inputs may include data collected during an interaction between the user 114 and the additional user 120, such as audio data of the additional user 120 or user 114 speaking or asking questions, visual feedback of the additional user's 120 and/or user 114 expressions and/or body language, biometrics, etc. Process 700 includes applying 710 model inputs to the interaction recommendation model. Model inputs may be applied to the interaction recommendation model in real-time, to generate one or more model outputs that may be transmitted to the user 114, such that the user 114 may use the model output during the interaction with the additional user 120. Model outputs may include an interaction recommendation message, such as a script to be communicated by the user 114, information (e.g., policy information), a warning, phrases or words to avoid, an emotional state of the additional users (e.g., frustrated, confused, saddened, or worried) and/or any additional or alternative feedback or recommendation that may assist the user 114 in their interaction with the additional user 120.

Applying model inputs to the model in real-time during a current interaction between the user 114 and the additional user 120, enables the system 100 and/or the interaction recommendation model to evaluate the interaction in real-time, e.g., evaluate the facial expressions, body language, etc., of the additional user 120 to determine an emotional state of the additional users, which may be particularly valuable for the user 114 to understand and/or recognize during additional user interactions.

Process 700 may further include, transmitting 712 the interaction recommendation to one or more user computing devices 130, e.g., physical space user computing device 132 and/or the virtual user computing device 136 during the current interaction.

Process 700 may further include, presenting 714, within the extended reality collaboration environment 112, e.g., to the physical space user 116 or virtual user 118, using the user computing device 134, the recommendation message. In certain embodiments, this action or operation may be performed by extended reality collaboration environment computing system 110 and/or collaboration module 144 (shown in FIG. 1). In some alternative embodiments, the recommendation message, or portions of the recommendation message, may be presented outside of the extended reality collaboration environment 112. In some embodiments, the collaboration system 100 may perform real-time translations, e.g., if the additional user's 120 language may be different than a language of the physical space user 116 and/or the virtual user 118.

In some embodiments, the process may include first transmitting the extended reality collaboration environment 150 to the virtual user computing device 136 for review and approval or editing, before an approved extended reality collaboration environment 150 may be transmitted to the physical space user computing device 132.

### Exemplary Computer-Implemented Method for Providing Custom Interactions for a User

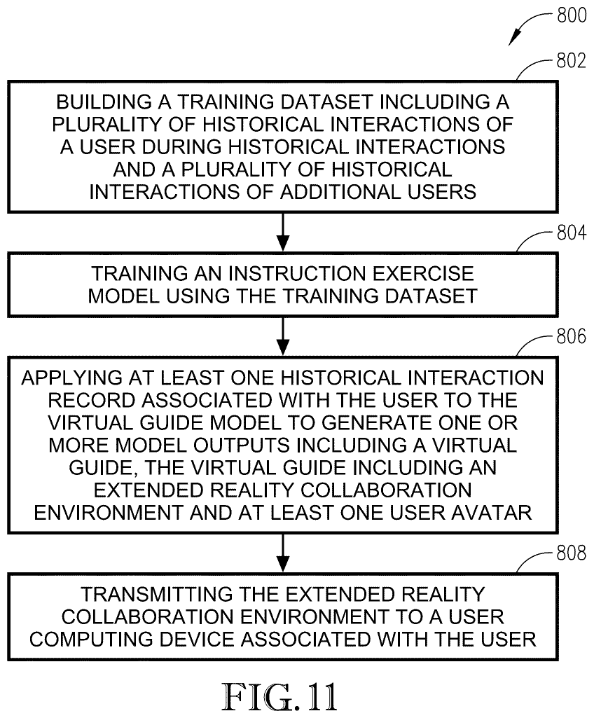

FIG. 11 depicts a flow chart of an exemplary computer-implemented process 800 for generating an interaction for training or teaching purposes or to enable interactions between the user 114 and an additional user 120. The virtual guide 122 may correspond to an extended reality collaboration environment 112, using collaboration system 100 and/or the collaboration module 144 shown in FIG. 1. Process 800 may be implemented by a computing device, for example the extended reality collaboration environment computing system 110 and/or collaboration module 144 (shown in FIG. 1). In the exemplary embodiment, the extended reality collaboration environment computing system 110 may be in communication with one or more collaboration modules 144 and one or more user computing devices 130 (both shown in FIG. 1).

In the exemplary embodiment, process 800 may further include, building 802 a training dataset including a plurality of historical physical space user interaction interactions 142, associated with a historical virtual guide 122 of the physical space user 116, and/or any suitable historical interactions between the user 114 and the additional users(s) 120. In certain embodiments, the training dataset including a plurality of historical interactions from the one or more users associated with the extended reality collaboration environment and including location data for the physical space associated with the extended reality collaboration environment. The historical user interaction record may include additional or alternative data, for example, the historical user interaction may be scored, ranked, and/or additional feedback data from the user 114 may be included data in the historical user interaction record.

Process 800 may include building the historical physical space user interaction interactions 142 by receiving and/or saving sensor data from one or more user computing devices 130, e.g., the physical space user computing device 132, the virtual user computing device 136, and/or the additional user computing device 138, during the historical interaction, to create a historical instruction record.

In some embodiments, building the training dataset or creating/updating historical user interactions 142 may be performed by the extended reality collaboration environment computing system 110 and/or collaboration module 144 (shown in FIG. 1).

Process 800 may further include training 804, using one or more machine learning and/or artificial intelligence techniques, an interaction model using the training dataset, e.g., for the physical space Training 804 may include training or re-training using updated or new historical interactions, tuning, adjusting weighting factors, etc., in order to generate the interaction model. The interaction model may be trained to generate one or more model outputs when one or more model inputs are applied to the interaction recommendation model. Model inputs may include one or more historical user interaction records, e.g., a most recently completed interaction completed by the user 114. For example, model inputs may include data collected during an interaction between the user 114 and the additional user 120, such as audio data of the additional user 120 or user 114 speaking or asking questions, visual feedback of the additional user's 120 and/or user 114 expressions and/or body language, biometrics, etc., collected during the interaction.

Process 700 includes applying 806 model inputs to the interaction model to generate one or more model outputs including a new or updated virtual guide 122. Applying 806 may include applying inputs (e.g., sensor data) to the virtual guide model to generate a virtual guide 122 to enable interactions of the one or more users within the extended reality collaboration environment and/or within the physical space. The new or updated virtual guide 122 may be a correspond to a specific interaction that may be best suited and customized for a specific user 114 based on the prior behavior or performance of the user 114 during historical interactions. The new virtual guide 122 may include one or more extended reality collaboration environment 112 and one or more additional users' avatars 148.

Applying 806 model inputs to the interaction model may generate one or more additional or alternative model outputs. For example, model outputs may include a score that evaluates the performance of the user 114 and/or feedback describing the performance of the user 114. The model outputs including the score and feedback, may reduce the workload on the user 114. In another example, model outputs may include a recommendation and/or one or more criteria for subsequent virtual guides 122 that should be conducted by the user 114. In certain embodiments, recommendations may be used to select a virtual guide 122 from a list of available pre-existing virtual guides 122 or, the recommendation may be used to assign the user 114 to an incoming interaction, e.g., an interaction with an additional user 120.

In the exemplary embodiment, process 700 may further include, transmitting 712 the virtual guide 122, and one or more other model outputs, to one or more user computing devices 130, e.g., physical space user computing device 132 and/or the virtual user computing device 136.

### Exemplary Embodiments & Functionality

In one aspect, a computing system for generating a virtual reality replicant user for interaction with at least one user may be provided. The computing system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, dermal patches, voice bots, chatbots, ChatGPT or ChatGPT-based bots, and/or other electronic or electrical components, which may be in wired or wireless communication with one another. For example, in one instance, the computing system may include at least one local or remote processor and/or associated transceiver in communication with at least one local or remote memory device and in communication with a user computing device associated with a user and with an interface of user computing device associated with a user. The at least one processor may be programmed to: i) communicate with one or more user devices to cause the one or more user devices to present the extended reality collaboration environment including a personalized avatar of a first user associated with a first user device of the one or more user devices, wherein the extended reality collaboration environment corresponds to a real-time representation of a physical space, ii) receive sensor data from a sensor including data representing the physical space, the sensor data comprising sensor data from at least one of: a camera, a microphone, a motion sensor, an environmental sensor, and other sensor devices configured to capture real-time and/or historical aspects of the physical space, iii) generate the extended reality collaboration environment corresponding to the physical space based at least upon the received sensor data, wherein the extended reality collaboration environment comprises a virtual representation of the physical space with the personalized avatar of the first user, iv) receive user sensor data from the first user device, the user sensor data corresponding to user inputs from the first user device, v) enable interaction between the first user and the physical space within the extended reality collaboration environment on the user inputs from the first user device, and/or vi) present the interaction between the first user and the physical space within the extended reality collaboration environment on the one or more additional user devices. The computing system may have additional, less, or alternate functionality, including that discussed elsewhere herein.

In another aspect, a computing-based or computer-implemented method for generating a virtual reality replicant persona for interaction with at least one user may be provided. The method may be implemented by a computing system including any of the electronic or electrical components discussed herein. For instance, the method may be implemented by at least one processor in communication with at least one memory device and in communication with a user computing device associated with a user and with an interface of user computing device associated with a virtual user 118. The method may include: i) communicating with one or more user devices to cause the one or more user devices to present the extended reality collaboration environment including a personalized avatar of a first user associated with a first user device of the one or more user devices, wherein the extended reality collaboration environment corresponds to a real-time representation of a physical space, ii) receiving sensor data from a sensor including data representing the physical space, the sensor data comprising sensor data from at least one of: a camera, a microphone, a motion sensor, an environmental sensor, and other sensor devices configured to capture real-time and/or historical aspects of the physical space, iii) generating the extended reality collaboration environment corresponding to the physical space based at least upon the received sensor data, wherein the extended reality collaboration environment comprises a virtual representation of the physical space with the personalized avatar of the first user, iv) receiving user sensor data from the first user device, the user sensor data corresponding to user inputs from the first user device, v) enabling interaction between the first user and the physical space within the extended reality collaboration environment on the user inputs from the first user device, and/or vi) presenting the interaction between the first user and the physical space within the extended reality collaboration environment on the one or more additional user devices. The method may include additional, less, or alternate actions, including those discussed elsewhere herein.

In yet another aspect, at least one non-transitory computing-readable media having computing-executable instructions embodied thereon may be disclosed, the computing-executable instructions when executed by a computing system including at least one processor in communication with at least one memory device and in communication with a user computing device associated with a user and with an interface of user computing device associated with a virtual user 118, the computing-executable instructions cause the at least one processor to: i) communicate with one or more user devices to cause the one or more user devices to present the extended reality collaboration environment including a personalized avatar of a first user associated with a first user device of the one or more user devices, wherein the extended reality collaboration environment corresponds to a real-time representation of a physical space, ii) receive sensor data from a sensor including data representing the physical space, the sensor data comprising sensor data from at least one of: a camera, a microphone, a motion sensor, an environmental sensor, and other sensor devices configured to capture real-time and/or historical aspects of the physical space, iii) generate the extended reality collaboration environment corresponding to the physical space based at least upon the received sensor data, wherein the extended reality collaboration environment comprises a virtual representation of the physical space with the personalized avatar of the first user, iv) receive user sensor data from the first user device, the user sensor data corresponding to user inputs from the first user device, v) enable interaction between the first user and the physical space within the extended reality collaboration environment on the user inputs from the first user device, and/or vi) present the interaction between the first user and the physical space within the extended reality collaboration environment on the one or more additional user devices. The computing system may have additional, less, or alternate functionality, including that discussed elsewhere herein. The computing-executable instructions may direct additional, less, or alternate functionality, including that discussed elsewhere herein.

### Machine Learning & Other Matters

The computer-implemented methods discussed herein may include additional, less, or alternate actions, including those discussed elsewhere herein. The methods may be implemented via one or more local or remote processors, transceivers, and/or sensors (such as processors, transceivers, and/or sensors mounted on vehicles or mobile devices, or associated with smart infrastructure or remote servers), and/or via computing-executable instructions stored on non-transitory computing-readable media or medium.

Additionally, the computing systems discussed herein may include additional, less, or alternate functionality, including that discussed elsewhere herein. The computing systems discussed herein may include or be implemented via computing-executable instructions stored on non-transitory computing-readable media or medium.

A processor or a processing element may be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally, or alternatively, the machine learning programs may be trained by inputting sample data sets or certain data into the programs, such as image, mobile device, vehicle telematics, and/or intelligent home telematics data. The machine learning programs may utilize deep learning algorithms that may be primarily focused on pattern recognition and may be trained after processing multiple examples. The machine learning programs may include Bayesian program learning (BPL), voice recognition and synthesis, image or object recognition, optical character recognition, and/or natural language processing—either individually or in combination. The machine learning programs may also include natural language processing, semantic analysis, automatic reasoning, and/or machine learning.

In supervised machine learning, a processing element may be provided with example inputs and their associated outputs and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs. In one embodiment, machine learning techniques may be used to extract the relevant personal belonging and/or home feature information for additional users from mobile device sensors, vehicle-mounted sensors, home-mounted sensors, drone mounted sensors, and/or other sensor data, vehicle or home telematics data, image data, and/or other data.

In one embodiment, a processing element may be trained by providing it with a large sample of conventional analog and/or digital, still and/or moving (i.e., video) image data, telematics data, and/or other data of belongings, household goods, durable goods, appliances, electronics, homes, etc. with known characteristics or features. Such information may include, for example, make or manufacturer and model information.

Based upon these analyses, the processing element may learn how to identify characteristics and patterns that may then be applied to analyzing sensor data, vehicle or home telematics data, image data, mobile device data, and/or other data. For example, the processing element may learn, with the additional users permission or affirmative consent, to identify the type and number of goods within the home, and/or purchasing patterns of the additional user, such as by analysis of virtual receipts, additional users virtual accounts with online or physical retailers, mobile device data, interconnected or smart home data, interconnected or smart vehicle data, etc. For the goods identified, a virtual inventory of personal items or personal articles may be maintained current and up to date. As a result, at the time of an interaction that damages the additional users' home or goods, providing prompt and accurate service to the additional user may be provided—such as accurate insurance claim handling, and prompt repair or replacement of damaged items for the additional user.

In some embodiments, voice bots or chatbots, such as those discussed herein, may be configured to utilize AI (artificial intelligence) and/or ML (machine learning) techniques. For instance, the chatbot may be a large language model such as OpenAI GPT-4, Meta LlaMa, or Google PaML 2. The voice bot or chatbot may employ supervised or unsupervised ML techniques, which may be followed by, and/or used in conjunction with, reinforced or reinforcement learning techniques. The voice bot or chatbot may employ the techniques utilized for ChatGPT.

### Additional Considerations

As will be appreciated based upon the foregoing specification, the above-described embodiments of the disclosure may be implemented using computing programming or engineering techniques including computing software, firmware, hardware or any combination or subset thereof. Any such resulting program, having computing-readable code means, may be embodied, or provided within one or more computing-readable media, thereby making a computing program product, i.e., an article of manufacture, according to the discussed embodiments of the disclosure. The computing-readable media may be, for example, but may be not limited to, a fixed (hard) drive, diskette, optical disk, magnetic tape, semiconductor memory such as read-only memory (ROM), and/or any transmitting/receiving medium, such as the Internet or other communication network or link. The article of manufacture containing the computing code may be made and/or used by executing the code directly from one medium, by copying the code from one medium to another medium, or by transmitting the code over a network.

These computing programs (also known as programs, software, software applications, “apps,” or code) include machine instructions for a programmable processor and can be implemented in a high-level procedural and/or object-oriented programming language, and/or in assembly/machine language. As used herein, the terms “machine-readable medium” “computing-readable medium” refers to any computing program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computing-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object-oriented databases, and any other structured or unstructured collection of interactions 142 or data that may be stored in a computing system. The above examples are not intended to limit in any way the definition and/or meaning of the term database. Examples of RDBMS's include, but are not limited to, Oracle® Database, MySQL, IBM® DB2, Microsoft® SQL Server, Sybase®, and PostgreSQL. However, any database may be used that enables the systems and methods described herein. (Oracle may be a registered trademark of Oracle Corporation, Redwood Shores, California; IBM may be a registered trademark of International Business Machines Corporation, Armonk, New York; Microsoft may be a registered trademark of Microsoft Corporation, Redmond, Washington; and Sybase may be a registered trademark of Sybase, Dublin, California.)

As used herein, the terms “software” and “firmware” are interchangeable and include any computing program stored in memory for execution by a processor, including RAM memory, ROM memory, EPROM memory, EEPROM memory, and non-volatile RAM (NVRAM) memory. The above memory types are example only and are thus not limiting as to the types of memory usable for storage of a computing program.

In another embodiment, a computing program may be provided, and the program may be embodied on a computing-readable medium. In one exemplary embodiment, the system may be executed on a single computing system, without requiring a connection to a server computing. In a further exemplary embodiment, the system may be being run in a Windows® environment (Windows may be a registered trademark of Microsoft Corporation, Redmond, Washington). In yet another embodiment, the system may be run on a mainframe environment and a UNIX® server environment (UNIX may be a registered trademark of X/Open Company Limited located in Reading, Berkshire, United Kingdom). In a further embodiment, the system may be run on an iOS® environment (iOS may be a registered trademark of Cisco Systems, Inc. located in San Jose, CA). In yet a further embodiment, the system may be run on a Mac OS® environment (Mac OS may be a registered trademark of Apple Inc. located in Cupertino, CA). In still yet a further embodiment, the system may be run on Android® OS (Android may be a registered trademark of Google, Inc. of Mountain View, CA). In another embodiment, the system may be run on Linux® OS (Linux may be a registered trademark of Linus Torvalds of Boston, MA). The application may be flexible and designed to run in various different environments without compromising any major functionality.

In some embodiments, the system includes multiple components distributed among a plurality of computing devices. One or more components may be in the form of computing-executable instructions embodied in a computing-readable medium. The systems and processes are not limited to the specific embodiments described herein. In addition, components of each system and each process may be practiced independent and separate from other components and processes described herein. Each component and process may also be used in combination with other assembly packages and processes. The present embodiments may enhance the functionality and functioning of computer and/or computing systems.

As used herein, an element or action or operation recited in the singular and preceded by the word “a” or “an” should be understood as not excluding plural elements or action or operations, unless such exclusion may be explicitly recited. Furthermore, references to “exemplary embodiment” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language may be expressly recited, such as “means for” or “action or operation for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure may be defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A computing system for collaborative interactions between virtual and real-world environments using an extended reality collaboration environment, the computing system comprising at least one memory device and at least one processor in communication with the at least one memory device, the at least one processor configured to:
communicate with one or more user devices to cause the one or more user devices to present the extended reality collaboration environment including a personalized avatar of a first user associated with a first user device of the one or more user devices, wherein the extended reality collaboration environment corresponds to a real-time representation of a physical space;
receive sensor data from a sensor including data representing the physical space, the sensor data comprising sensor data from at least one of: a camera, a microphone, a motion sensor, an environmental sensor, and other sensor devices configured to capture real-time and/or historical aspects of the physical space;
generate the extended reality collaboration environment corresponding to the physical space based at least upon the received sensor data, wherein the extended reality collaboration environment comprises a virtual representation of the physical space with the personalized avatar of the first user;
receive user sensor data from the first user device, the user sensor data corresponding to user inputs from the first user device;
enable interaction between the first user and the physical space within the extended reality collaboration environment based upon the user inputs from the first user device; and
present the interaction between the first user and the physical space within the extended reality collaboration environment on the one or more additional user devices.

2. The computing system of claim 1, wherein the at least one processor is further configured to:
build a training dataset including a plurality of historical interactions from the one or more users associated with the extended reality collaboration environment and including location data for the physical space associated with the extended reality collaboration environment;
train, using one or more machine learning and/or artificial intelligence techniques, a virtual guide model using the training dataset for the physical space; and
apply user sensor data to the virtual guide model to generate a virtual guide to enable interactions of the one or more users within the extended reality collaboration environment and/or within the physical space.

3. The computing system of claim 2, wherein the virtual guide provides one or more outputs to the one or more users in the extended reality collaboration environment, the one or more outputs comprising: a map of the physical space, navigation instructions associated with the physical space, collaborative elements that are accessible within the extended reality collaboration environment or the physical space, and one or more virtual or real interactions between the one or more users and the extended reality collaboration environment and/or the physical space.

4. The computing system of claim 1, wherein the at least one processor is further configured to:
build a training dataset including a plurality of historical interactions from the one or more users in the physical space associated with the extended reality collaboration environment and including location data for the physical space associated with the extended reality collaboration environment;
train, using one or more machine learning and/or artificial intelligence techniques, an interaction recommendation model, using the training dataset for the physical space; and
apply user sensor data to the interaction recommendation model for a virtual guide to generate recommendations enabling user interactions within the extended reality collaboration environment and the corresponding physical space.

5. The computing system of claim 1, wherein the one or more user devices comprise at least one of a virtual reality device, an augmented reality device, or an extended reality device.

6. The computing system of claim 1, wherein the memory stores a plurality of the extended reality collaboration environments, each of the extended reality collaboration environments comprising one or more collaborative elements corresponding to a physical collaborative element within the physical space and a virtual collaborative element within the extended reality collaboration environment, wherein the at least one processor is further configured to:
receive a criteria from at least one of the one or more user devices associated with at least one of the collaborative elements;
determine the extended reality collaboration environment the corresponding physical collaborative element and the virtual collaborative element based on the received criteria; and
transmit sensor data associated with the one or more collaborative elements to the one or more user devices and the physical space to enable interaction between the extended reality collaboration environment and the physical space.

7. The computing system of claim 6, wherein the collaborative element comprises at least one of: a document, a whiteboard, and a display device.

8. The computing system of claim 1, wherein the at least one processor is further configured to generate an avatar for the extended reality collaboration environment representing users within the physical space in the extended reality collaboration environment based on the sensor data from the sensor within the physical space.

9. The computing system of claim 1, wherein each of the user computing devices includes one or more sensors for collecting sensor data, wherein the sensors include a camera sensor, a microphone, a biometric sensor, a radar sensor, a LiDAR sensor, a pressure sensor, a temperature sensor, and a weather sensor.

10. The computing system of claim 1, wherein the processor is further configured to update the extended reality collaboration environment in response to receiving sensor data indicating a transition of the one or more users from the extended reality collaboration environment to the physical space.

11. A computer-implemented method for enabling collaborative interactions with a plurality of users in an extended reality collaboration environment, the computer-implemented method performed by a computing system including at least one memory device and one or more processors in communication with the at least one memory device and one or more user computing devices, the computer-implemented method comprising:
communicating, via the one or more processors, with one or more user devices to cause the one or more user devices to present the extended reality collaboration environment including a personalized avatar of a first user associated with a first user device of the one or more user devices, wherein the extended reality collaboration environment corresponds to a real-time representation of a physical space;
receiving, via the one or more processors, sensor data from a sensor including data representing the physical space, the sensor data comprising sensor data from at least one of: a camera, a microphone, a motion sensor, an environmental sensor, and other sensor devices configured to capture real-time and/or historical aspects of the physical space;
generating, via the one or more processors, the extended reality collaboration environment corresponding to the physical space based at least upon the received sensor data, wherein the extended reality collaboration environment comprises a virtual representation of the physical space with the personalized avatar of the first user;
receiving, via the one or more processors, user sensor data from the first user device, the user sensor data corresponding to user inputs from the first user device;
enabling, via the one or more processors, an interaction between the first user and the physical space within the extended reality collaboration environment on the user inputs from the first user device; and
presenting, via the one or more processors, the interaction between the first user and the physical space within the extended reality collaboration environment on the one or more additional user devices.

12. The computer-implemented method of claim 11, wherein the method further comprises:
building, via the one or more processors, a training dataset including a plurality of historical interactions from the one or more users associated with the extended reality collaboration environment and including location data for the physical space associated with the extended reality collaboration environment;
training, via the one or more processors and using one or more machine learning and/or artificial intelligence techniques, a virtual guide model using the training dataset for the physical space; and
applying, via the one or more processors, user sensor data to the virtual guide model to generate a virtual guide to enable interactions of the one or more users within the extended reality collaboration environment and/or within the physical space.

13. The computer-implemented method of claim 11, wherein the virtual guide provides one or more outputs to the one or more users in the extended reality collaboration environment, the one or more outputs comprising: a map of the physical space, navigation instructions associated with the physical space, collaborative elements that are accessible within the extended reality collaboration environment or the physical space, and one or more virtual or real interactions between the one or more users and the extended reality collaboration environment and/or the physical space.

14. The computer-implemented method of claim 12, further comprising:
building, via the one or more processors, a training dataset including a plurality of historical interactions from the one or more users in the physical space associated with the extended reality collaboration environment and including location data for the physical space associated with the extended reality collaboration environment;
training, via the one or more processors, using one or more machine learning and/or artificial intelligence techniques, an interaction recommendation model, using the training dataset for the physical space; and
applying, via the one or more processors, user sensor data to the interaction recommendation model for a virtual guide to generate recommendations enabling user interactions within the extended reality collaboration environment and the corresponding physical space.

15. The computer-implemented method of claim 11, wherein the one or more user devices include at least one of a virtual reality device, an augmented reality device, or an extended reality device.

16. The computer-implemented method of claim 11, wherein the memory stores a plurality of the extended reality collaboration environments, each of the extended reality collaboration environments including one or more collaborative elements corresponding to a physical collaborative element within the physical space and a virtual collaborative element within the extended reality collaboration environment, wherein the method further comprises:
receiving, via the one or more processors, criteria from at least one of the one or more user devices associated with at least one of the collaborative elements;
determining, via the one or more processors, the extended reality collaboration environment, the corresponding physical collaborative element, and the virtual collaborative element based on the received criteria; and
transmitting, via the one or more processors, sensor data associated with the one or more collaborative elements to the one or more user devices and the physical space to enable interaction between the extended reality collaboration environment and the physical space.

17. The computer-implemented method of claim 16, wherein the collaborative element includes at least one of: a document, a whiteboard, and a display device.

18. The computer-implemented method of claim 11, further comprising generating, via the one or more processors, an avatar for the extended reality collaboration environment representing users within the physical space in the extended reality collaboration environment based on the sensor data from the sensor within the physical space.

19. The computer-implemented method of claim 11, wherein each the user computing devices includes one or more sensors for collecting sensor data, wherein the sensors include a camera sensor, a microphone, a biometric sensor, a radar sensor, a LiDAR sensor, a pressure sensor, a temperature sensor, or a weather sensor.

20. At least one non-transitory computer-readable media having computing-executable instructions embodied thereon, wherein when executed by a computing system including at least one memory device and at least one processor in communication with the at least one memory device and in communication with one or more user computing devices, the computer-executable instructions cause the at least one processor to:
communicate with one or more user devices to cause the one or more user devices to present an extended reality collaboration environment including a personalized avatar of a first user associated with a first user device of the one or more user devices, wherein the extended reality collaboration environment corresponds to a real-time representation of a physical space;
receive sensor data from a sensor including data representing the physical space, the sensor data comprising sensor data from at least one of: a camera, a microphone, a motion sensor, an environmental sensor, and other sensor devices configured to capture real-time and/or historical aspects of the physical space;
generate the extended reality collaboration environment corresponding to the physical space based at least upon the received sensor data, wherein the extended reality collaboration environment comprises a virtual representation of the physical space with the personalized avatar of the first user;
receive user sensor data from the first user device, the user sensor data corresponding to user inputs from the first user device;
enable interaction between the first user and the physical space within the extended reality collaboration environment on the user inputs from the first user device; and
present the interaction between the first user and the physical space within the extended reality collaboration environment on the one or more additional user devices.
